(19) United States
(12) Patent Application Publication
(10) Pub. No.: US 2026/0046110 A1
(43) Pub. Date: Feb. 12, 2026

(54) ELECTRONIC APPARATUS AND CONTROLLING METHOD THEREOF

(71) Applicant: CRYPTO LAB INC., Seoul (KR)

(72) Inventors: Jaehyung Kim, Stanford, CA (US); Hyeongmin Choe, Seoul (KR); Elias Suvanto, Seoul (KR); Damien Stehle, Seoul (KR)

(21) Appl. No.: 19/291,011

(22) Filed: Aug. 5, 2025

(30) Foreign Application Priority Data
Aug. 5, 2024 (KR) 10-2024-0103819
Sep. 23, 2024 (KR) 10-2024-0128081
Feb. 14, 2025 (KR) 10-2025-0019661
Aug. 4, 2025 (KR) 10-2025-0106908

(51) Int. Cl. H04L 9/00; H04L 9/06

(52) U.S. Cl. CPC H04L 9/008; H04L 9/0618

(57) ABSTRACT

An electronic apparatus includes at least one processor including processing circuitry, and memory, wherein the at least one processor is configured to, based on an instruction for an operation for a first ciphertext, perform an operation action for the first ciphertext, obtain a second ciphertext including a noise based on the operation action, and based on identifying a predetermined event on the basis of a modulus of the second ciphertext, obtain an output ciphertext having a bigger modulus than the modulus of the second ciphertext by performing bootstrapping on the basis of a first scaling factor, a second scaling factor, and a third scaling factor different from one another, and perform an additional operation action based on the output ciphertext.

### TECHNICAL FIELD

The disclosure relates to an electronic apparatus and a controlling method thereof, and more particularly, to an electronic apparatus that performs a bootstrapping operation for a ciphertext in a homomorphic encryption environment, and a controlling method thereof.

### BACKGROUND ART

As communication technologies developed, and distribution of electronic apparatuses has become active, continuous efforts for maintaining communication security between electronic apparatuses are being made. Accordingly, in most communication environments, encryption/decryption technologies are being used.

When a message encrypted by an encryption technology is transmitted to a counterpart, the counterpart should perform decryption for using the message. In this case, waste of resources and time is generated for the counterpart in a process of decrypting the encrypted data. Also, in case hacking of a third party is performed while the counterpart temporarily decrypted the message for an operation, there is a problem that the message can be easily leaked to the third party.

For resolving such problems, a homomorphic encryption method is being studied. According to homomorphic encryption, even if an operation is performed in a ciphertext itself without decrypting the encrypted information, the same result as a value obtained by performing an operation for a plaintext and then encrypting the operation result can be obtained. Accordingly, various types of operations can be performed in a state of not decrypting a ciphertext.

Recently, there has been an effort to use a homomorphic ciphertext in a process of large language model (LLM) inference, and in the aforementioned inference process, high-dimensional matrix multiplications were required.

Accordingly, a method that enables effective performing of a high-dimensional matrix multiplication by using a homomorphic ciphertext was required.

As a high-dimensional matrix operation, a ciphertext-ciphertext matrix multiplication (CCMM) may be performed. As a ciphertext-ciphertext matrix multiplication (CCMM) is a multiplication operation between ciphertexts, a lot of resources may be needed. Also, as there is a lot of processing amount of data, the processing time may take long.

In particular, a modulus used for a calculation process may decrease in an operation process. If the modulus becomes smaller, a noise included in a ciphertext may become similar to the size of the modulus. If the noise included in the ciphertext becomes similar to the size of the modulus, there are problems that it is difficult to distinguish the original message and the noise, and decryption may fail or an operation is not possible anymore.

### DISCLOSURE OF INVENTION

### Solution to Problem

The disclosure was devised for improving the aforementioned problems, and the purpose of the disclosure is in providing an electronic apparatus that performs bootstrapping that expands a modulus of a ciphertext, and a controlling method thereof.

According to an embodiment, an electronic apparatus includes at least one processor including processing circuitry, and memory, wherein the at least one processor is configured to, based on an instruction for an operation for a first ciphertext, perform an operation action for the first ciphertext, obtain a second ciphertext including a noise based on the operation action, and based on identifying a predetermined event on the basis of a modulus of the second ciphertext, obtain an output ciphertext having a bigger modulus than the modulus of the second ciphertext by performing bootstrapping on the basis of a first scaling factor, a second scaling factor, and a third scaling factor different from one another, and perform an additional operation action based on the output ciphertext.

The modulus may be a reference value used for limiting a size of a number in an operation action.

The at least one processor may, based on the modulus of the second ciphertext being smaller than or equal to a threshold value, identify that the predetermined event occurred.

The at least one processor may, based on the second scaling factor different from the first scaling factor, obtain a coefficient-encoded third ciphertext by performing Slots-to-Coefficients (StC) conversion for the second ciphertext, and obtain the output ciphertext by performing modulus expansion for the third ciphertext.

The at least one processor may obtain a fourth ciphertext by performing ModRaise of expanding the modulus for the third ciphertext, and obtain the output ciphertext based on the fourth ciphertext.

The at least one processor may, based on the third scaling factor smaller than the second scaling factor, obtain a slot-encoded fifth ciphertext by performing first coefficients-to-slots (CtS) conversion for the fourth ciphertext, obtain a sixth ciphertext by filtering a second portion other than the first portion indicating an integer in the fifth ciphertext, and obtain the output ciphertext based on the sixth ciphertext.

The at least one processor may obtain a slot-encoded seventh ciphertext by performing second coefficients-to-slots (CtS) conversion for the fourth ciphertext based on the second scaling factor, and obtain the output ciphertext based on the sixth ciphertext and the seventh ciphertext.

The at least one processor may obtain an eight ciphertext indicating the output ciphertext by subtracting the sixth ciphertext from the seventh ciphertext.

The at least one processor may obtain the eight ciphertext by using the first scaling factor instead of the second scaling factor.

The at least one processor may obtain a remaining modulus based on a difference value between a modulus of the eighth ciphertext and a modulus of the second ciphertext, and perform the additional operation action based on the remaining modulus.

According to an embodiment, a controlling method of an electronic apparatus includes the steps of, based on an instruction for an operation for a first ciphertext, performing an operation action for the first ciphertext, obtaining a second ciphertext including a noise based on the operation action, and based on identifying a predetermined event on the basis of a modulus of the second ciphertext, obtaining an output ciphertext having a bigger modulus than the modulus of the second ciphertext by performing bootstrapping on the basis of a first scaling factor, a second scaling factor, and a third scaling factor different from one another, and performing an additional operation action based on the output ciphertext.

The modulus may be a reference value used for limiting a size of a number in an operation action.

In the step of obtaining the output ciphertext, based on the modulus of the second ciphertext being smaller than or equal to a threshold value, it may be identified that the predetermined event occurred.

In the step of obtaining the output ciphertext, based on the second scaling factor different from the first scaling factor, a coefficient-encoded third ciphertext may be obtained by performing Slots-to-Coefficients (StC) conversion for the second ciphertext, and the output ciphertext may be obtained by performing modulus expansion for the third ciphertext.

In the step of obtaining the output ciphertext, a fourth ciphertext may be obtained by performing ModRaise of expanding the modulus for the third ciphertext, and the output ciphertext may be obtained based on the fourth ciphertext.

In the step of obtaining the output ciphertext, based on the third scaling factor smaller than the second scaling factor, a slot-encoded fifth ciphertext may be obtained by performing first coefficients-to-slots (CtS) conversion for the fourth ciphertext, a sixth ciphertext may be obtained by filtering a second portion other than the first portion indicating an integer in the fifth ciphertext, and the output ciphertext may be obtained based on the sixth ciphertext.

In the step of obtaining the output ciphertext, a slot-encoded seventh ciphertext may be obtained by performing second coefficients-to-slots (CtS) conversion for the fourth ciphertext based on the second scaling factor, and the output ciphertext may be obtained based on the sixth ciphertext and the seventh ciphertext.

In the step of obtaining the output ciphertext, an eight ciphertext indicating the output ciphertext may be obtained by subtracting the sixth ciphertext from the seventh ciphertext.

In the step of obtaining the output ciphertext, the eight ciphertext may be obtained by using the first scaling factor instead of the second scaling factor.

In the step of performing the additional operation action, a remaining modulus may be obtained based on a difference value between a modulus of the eighth ciphertext and a modulus of the second ciphertext, and the additional operation action may be performed based on the remaining modulus.

### BRIEF DESCRIPTION OF DRAWINGS

FIG. 1 is a diagram for illustrating a configuration of a network system according to an embodiment;

FIG. 2 is a diagram for illustrating a configuration of a network system according to an embodiment;

FIG. 3 is a block diagram illustrating an electronic apparatus according to an embodiment;

FIG. 4 is a diagram for illustrating an operation of performing bootstrapping according to an embodiment;

FIG. 5 is a diagram for illustrating an operation of increasing a modulus according to an embodiment;

FIG. 6 is a diagram for illustrating an operation module and a bootstrapping module according to an embodiment;

FIG. 7 is a diagram for illustrating an operation of obtaining a ciphertext wherein a modulus was increased according to an embodiment;

FIG. 8 is a diagram for illustrating a bootstrapping module according to an embodiment;

FIG. 9 is a diagram for illustrating a change of a modulus in a bootstrapping operation according to an embodiment;

FIG. 10 is a diagram for illustrating an operation of controlling precision in a bootstrapping operation according to an embodiment;

FIG. 11 is a diagram for illustrating an operation of converting an integer according to an embodiment;

FIG. 12 is a diagram for illustrating a bit cleaning operation according to an embodiment;

FIG. 13 is a diagram for illustrating a bit cleaning operation according to an embodiment;

FIG. 14 is a diagram for illustrating a bootstrapping operation according to an embodiment; and

FIG. 15 is a diagram for illustrating a bit cleaning operation according to an embodiment.

### MODE FOR INVENTION

Hereinafter, the disclosure will be described in detail with reference to the accompanying drawings.

As terms used in the embodiments of the disclosure, general terms that are currently used widely were selected as far as possible, in consideration of the functions described in the disclosure. However, the terms may vary depending on the intention of those skilled in the art, previous court decisions, or emergence of new technologies, etc. Also, in particular cases, there may be terms that were arbitrarily designated by the applicant, and in such cases, the meaning of the terms will be described in detail in the relevant descriptions in the disclosure. Accordingly, the terms used in the disclosure should be defined based on the meaning of the terms and the overall content of the disclosure, but not just based on the names of the terms.

Also, in this specification, expressions such as “have,” “may have,” “include,” and “may include” denote the existence of such characteristics (e.g.: elements such as numbers, functions, operations, and components), and do not exclude the existence of additional characteristics.

In addition, the expression “at least one of A and/or B” should be interpreted to mean any one of “A” or “B” or “A and B.”

Further, the expressions “first,” “second” and the like used in this specification may be used to describe various elements regardless of any order and/or degree of importance. Also, such expressions are used only to distinguish one element from another element, and are not intended to limit the elements.

Meanwhile, the description in the disclosure that one element (e.g.: a first element) is “(operatively or communicatively) coupled with/to” or “connected to” another element (e.g.: a second element) should be interpreted to include both the case where the one element is directly coupled to the another element, and the case where the one element is coupled to the another element through still another element (e.g.: a third element).

Also, singular expressions include plural expressions, unless defined obviously differently in the context. Further, in the disclosure, terms such as “include” or “consist of” should be construed as designating that there are such characteristics, numbers, steps, operations, elements, components, or a combination thereof described in the specification, but not as excluding in advance the existence or possibility of adding one or more of other characteristics, numbers, steps, operations, elements, components, or a combination thereof.

In addition, in the disclosure, “a module” or “a part” performs at least one function or operation, and may be implemented as hardware or software, or as a combination of hardware and software. Also, a plurality of “modules” or “parts” may be integrated into at least one module and implemented as at least one processor, except “a module” or “a part” that needs to be implemented as specific hardware.

Further, in this specification, the term “user” may refer to a person who uses an electronic apparatus or an apparatus using an electronic apparatus (e.g.: an artificial intelligence electronic apparatus).

Also, in the disclosure, “a value” is defined as a concept including not only a scalar value but also a vector.

In addition, the mathematical operations and calculation in each step of the disclosure that will be described below can be implemented as computer operations by a coding method known for performing such operations or calculation and/or coding appropriately designed for the disclosure.

Also, the specific mathematical formulae that will be described below are suggested as examples among several possible alternatives, and the scope of the disclosure is not intended to be interpreted to be limited to the mathematical formulae mentioned in the disclosure.

For the convenience of explanation, notations will be defined as follows.

a←D: An element (a) is selected according to a distribution (D).

s1, s2∈R: Each of S1 and S2 is an element belonging to a set R.

mod(q): A modular operation is performed with an element q.

└⋅┐: The inside value is rounded off.

Hereinafter, various embodiments of the disclosure will be described in detail with reference to the accompanying drawings.

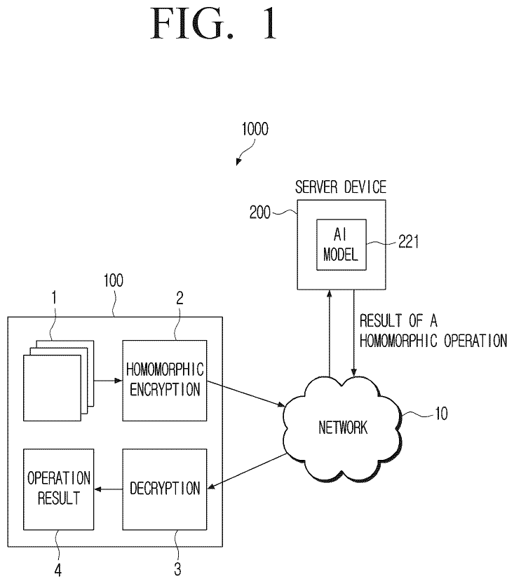

FIG. 1 is a diagram for illustrating a configuration of a network system 1000 according to an embodiment.

Referring to FIG. 1, an electronic apparatus 100 and a server device 200 may perform communication with each other through a network 10. The network 10 may be implemented as various forms of wired and wireless communication networks, broadcasting communication networks, optical communication networks, cloud networks, etc., and each device may be connected by methods such as Wi-Fi, Bluetooth, Near Field Communication (NFC), etc. without a separate medium.

In FIG. 1, one electronic apparatus 100 was illustrated, but the electronic apparatus 100 may be implemented as a plurality of various types. As an example, the electronic apparatus 100 may be apparatuses in various forms such as a smartphone, a tablet, a PC, a laptop PC, a home server, a kiosk, a game player, a camera, etc. Other than the above, the electronic apparatus 100 may also be implemented in a form of a home appliance to which an IoT function is applied.

As an example, in case a camera is included in the electronic apparatus 100, the electronic apparatus 100 may photograph at least one piece of original data 1 by itself and obtain the data. In case a camera is not included, the electronic apparatus 100 may be provided with the original data 1 from an external device (e.g., a camera, a memory stick, etc.) through various types of wired or wireless interfaces. In the various embodiments of the disclosure, the original data 1 may be a photo image, but is not necessarily limited thereto, and it may also be a graphic image. Alternatively, the original data 1 may also be a video content including a plurality of image frames.

The electronic apparatus 100 may obtain a homomorphic ciphertext by performing homomorphic encryption 2 for the at least one piece of original data, and then transmit the homomorphic ciphertext to the server device 200 through the network 10.

In this case, in the process wherein the original data 1 is transmitted, there may be a possibility that the data is hacked and leaked to the outside, or is leaked by the manager of the server device 200. However, if the original data is transmitted in a form of a homomorphic ciphertext, the original data cannot be identified even if it is leaked to the outside. Accordingly, security regarding personal information or physical characteristics of the user can be intensified.

There may be various homomorphic encryption algorithms for generating homomorphic ciphertexts, but in the various embodiments of the disclosure, explanation will be described based on a case wherein homomorphic encryption is performed by using a CKKS Scheme or a modified algorithm based on it.

For transmitting the original data in a form of a homomorphic ciphertext, the electronic apparatus 100 may perform encoding. In homomorphic encryption, encoding may be a task of converting data in an encryptable format. As homomorphic encryption is based on a mathematical structure (e.g., a polynomial operation), in the case of the original data 1, it may be converted into a form that can be processed by a homomorphic encryption algorithm, and then homomorphic encryption may be performed.

In homomorphic encryption, a slot encoding method and a coefficient encoding method may be used in general.

Slot encoding is a method of allotting data to be encrypted into a plurality of slots, and then encoding them in an entire slot unit. A slot means a data unit that can be stored in parallel in one homomorphic ciphertext. In case a ciphertext is expressed in a form of a polynomial, the coefficients or the roots of the polynomial may perform roles of each slot. If one ciphertext consists of n slots in total, n values may be encoded or operated simultaneously. In other words, if slot encoding is performed, a parallel computation for a homomorphic ciphertext may be performed. The slot encoding method may vary according to a homomorphic encryption algorithm. The aforementioned CKKS Scheme may perform slot encoding by using Fast Fourier Transform (FFT).

Coefficient encoding is a method of converting data to be encrypted into a form of a polynomial, and converting the coefficients of the polynomial into encrypted values. The aforementioned CKKS Scheme may perform coefficient encoding by using Discrete Fourier Transform (DFT).

According to an embodiment of the disclosure, the electronic apparatus 100 may perform CinS encoding. CinS encoding means a method of performing slot encoding, and then encoding by performing DFT for a plurality of slot sections but not the entire slots. Detailed explanation in this regard will be described in the parts described below.

Data encoded by the CinS encoding method is referred to as CinS encoding data in the disclosure. The electronic apparatus 100 transmits a homomorphic ciphertext which is a result of performing homomorphic encryption (2) for CinS encoding data to the server device 200.

The server device 200 is a device for performing an operation for a homomorphic ciphertext provided from the electronic apparatus 100 (i.e., at least one piece of original data that was homomorphically encrypted) in a homomorphically encrypted state, and providing a result of the homomorphic operation. The server device 200 may be implemented in various forms such as a web server, a cloud server, etc.

In the server device 200, an AI model 221 for performing an operation in an encrypted state may be stored. In the case of intending to be provided with the original data and performing an operation based on the original data as described above, the AI model 221 may be a convolutional neural network (CNN), but is not necessarily limited thereto.

Specifically, the AI model 221 may perform various operations for a homomorphic ciphertext encrypted by a homomorphic encryption (e.g., the CKKS Scheme) technology, and output the operation result in a form of a homomorphic ciphertext. Hereinafter, an operation result output in a form of a homomorphic ciphertext will be referred to as an encryption operation result.

In case the AI model 221 consists of a CNN, the AI model 221 of the server device 200 performs a convolution operation for each depth or a convolution operation for a homomorphic ciphertext transmitted from the electronic apparatus 100 by using a model parameter. Such an operation method will be described in detail in the parts described below.

The server device 200 transmits an encryption operation result to the electronic apparatus 100 through the network 10. The electronic apparatus 100 may decrypt (3) the received encryption operation result, and provide the operation result (4) to the user. The method of providing a result may vary according to the type and the configuration of the electronic apparatus 100.

As an example, in case the electronic apparatus 100 includes a built-in display, or is connected to an external display (e.g., a monitor), the electronic apparatus 100 may display the decrypted operation result (4).

As an example, in case the electronic apparatus 100 includes a speaker, the electronic apparatus 100 may output a voice message corresponding to the operation result through the speaker.

As an example, in case the electronic apparatus 100 performs communication with another terminal device (e.g., a smartphone, etc.), the electronic apparatus 100 may transmit the decrypted operation result to the terminal device.

As an example, in case the AI model 221 is a model trained to diagnose whether the user has a disease, the operation result may include information on whether the user has a disease, the type of the disease, the proceeding situation, etc. diagnosed based on the original data 1 of the user.

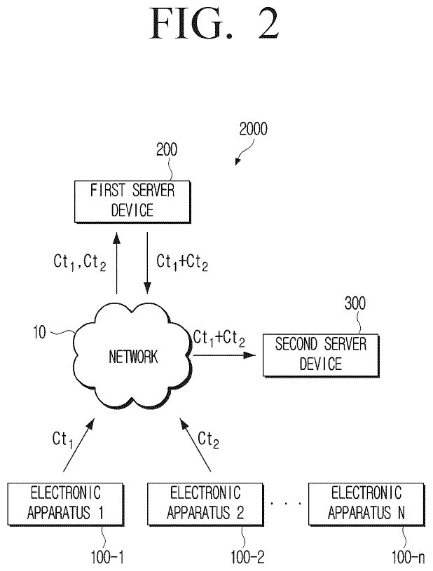

FIG. 2 is a diagram for illustrating a configuration of a network system 2000 according to an embodiment.

Referring to FIG. 2, the network system may include a plurality of electronic apparatuses 100-1-100-n, a first server device 200, and a second server device 300, and each component may be connected with one another through the network 10.

The network 10 may be implemented as various forms of wired and wireless communication networks, broadcasting communication networks, optical communication networks, cloud networks, etc., and each device may be connected by methods such as Wi-Fi, Bluetooth, Near Field Communication (NFC), etc. without a separate medium.

In FIG. 2, it was illustrated that there are a plurality of electronic apparatuses 100-1-100-n, but a plurality of electronic apparatuses do not necessarily have to be used, and one apparatus may be used. As an example, the electronic apparatuses 100-1-100-n may be implemented as apparatuses in various forms such as a smartphone, a tablet, a game player, a PC, a laptop PC, a home server, a kiosk, etc., and may also be implemented in a form of a home appliance to which an IoT function is applied other than them.

The user may input various types of information through the electronic apparatuses 100-1-100-n that the user uses. The input information may be stored in the electronic apparatuses 100-1-100-n themselves, but may also be transmitted to an external device and stored for reasons of the storage capacity and security, etc. In FIG. 2, the first server device 200 may perform a role of storing such information, and the second server device 300 may perform a role of using some or all of the information stored in the first server device 200.

Each electronic apparatus 100-1-100-n may homomorphically encrypt the input information, and transmit a homomorphic ciphertext to the first server device 200.

Each electronic apparatus 100-1-100-n may include an encryption noise, i.e., an error calculated in a process of performing homomorphic encryption in the ciphertext. Specifically, homomorphic ciphertexts generated in each electronic apparatus 100-1-100-n may be generated in a form wherein a result value including a message and an error value is restored when the ciphertext is decrypted by using a secret key later.

As an example, homomorphic ciphertexts generated in the electronic apparatuses 100-1-100-n may be generated in a form that satisfies the property as follows when the ciphertext is decrypted by using a secret key.

$$Dec ( ct , sk ) = 〈 ct , sk 〉 = M + e ( mod q ) \qquad [ Formula 1 ]$$

Here, <,> means a usual inner product, ct means a ciphertext, sk means a secret key, M means a plaintext message, e means an encryption error value, and mod q means a modulus of a ciphertext. q should be selected to be bigger than a result value M of multiplying a message by a scaling factor Δ. If an absolute value of the error value e is sufficiently smaller than M, a decryption value of the ciphertext M+e is a value that can replace the original message by the same precision in a significant figures operation. In the decrypted data, the error may be arranged on the side of the least significant bit (LSB), and M may be arranged on the side of the second least significant bit.

In case a size of a message is too small or too big, the size may be adjusted by using a scaling factor. If a scaling factor is used, not only a message in an integer form but also a message in a real number form can be encrypted, and thus usability can be increased greatly. Also, as a size of a message is adjusted by using a scaling factor, a size of an area wherein messages exist, i.e., an effective area in a ciphertext after an operation was performed may also be adjusted.

According to an embodiment, a modulus q of a ciphertext may be used by being set as various forms. As an example, a modulus of a ciphertext may be set as a form of q=Δ^{L} which is an exponent of a scaling factor Δ. If Δ is 2, it may be set as a value like q=2¹⁰.

Also, while explanation is described by assuming that a fixed-point is used in a homomorphic ciphertext according to the disclosure, but the disclosure can also be applied to a case wherein a floating point is used.

The first server device 200 may not decrypt the received homomorphic ciphertext, but store it in a state of a ciphertext.

The second server device 300 may request a specific processing result for the homomorphic ciphertext to the first server device 200. The first server device 200 may perform a specific operation according to the request of the second server device 300, and transmit the result to the second server device 300.

As an example, in case ciphertexts ct1 and ct2 transmitted by two electronic apparatuses 100-1, 100-2 are stored in the first server device 200, the second server device 300 may request a value of summing up the information provided from the two electronic apparatuses 100-1, 100-2 to the first server device 200. The first server device 200 may perform an operation of summing up the two ciphertexts according to the request, and then transmit the result value (ct1+ct2) to the second server device 300.

Because of a property of a homomorphic ciphertext, the first server device 200 may perform an operation in a state wherein decryption was not performed, and the result value also becomes a form of a ciphertext. In the disclosure, a result value obtained by an operation is referred to as an operation result ciphertext.

The first server device 200 may transmit the operation result ciphertext to the second server device 300. The second server device 300 may decrypt the received operation result ciphertext, and obtain an operation result value of the data included in each homomorphic ciphertext.

Meanwhile, the electronic apparatus 100 may obtain a homomorphic ciphertext by using a residual number system (RNS) modulus including a plurality of moduli having a size corresponding to a word size of the electronic apparatus 100, and perform an operation for the homomorphic ciphertext by using a rational rescale. According to one or more embodiments, the plurality of moduli may include sprout moduli consisting of a multiplication of decimals having a size smaller than or equal to the word size, and the electronic apparatus 100 may perform various operations (e.g., a key switching operation, etc.) for the homomorphic ciphertext by using the sprout moduli. According to one or more embodiments, the electronic apparatus 100 may perform a key switching operation for the homomorphic ciphertext by generating a middle modulus by upscaling the RNS modulus, performing a key switching operation for the middle modulus, and performing rescaling for the middle modulus for which the key switching operation was performed.

By this, the electronic apparatus 100 can perform an effective multiplication operation while minimizing the number of the RNS moduli, and thus a swifter operation for a homomorphic ciphertext becomes possible.

Meanwhile, in FIG. 2, a case wherein encryption is performed in the first electronic apparatus and the second electronic apparatus, and the second server device performs decryption was illustrated, but the disclosure is not necessarily limited thereto.

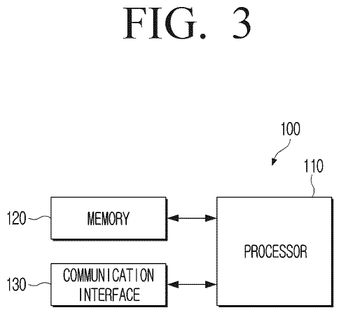

FIG. 3 is a block diagram for illustrating a configuration of an electronic apparatus according to an embodiment.

Referring to FIG. 3, the electronic apparatus 100 may include at least one processor 110 including processing circuitry, and memory 120 storing instructions. The at least one processor 110 may perform the following operations by executing the instructions.

The electronic apparatus 100 may include at least one processor 110 including processing circuitry, and memory 120.

The at least one processor 110 may receive an instruction for an operation from an external device or the user.

As an example, the electronic apparatus 100 may include a communication interface 130. The at least one processor 110 may receive an instruction for an operation or a ciphertext which becomes a subject for an instruction for an operation through the communication interface 130. As an example, there may be a plurality of ciphertexts.

The at least one processor 110 may perform an operation action for a first ciphertext (Δ₁m) based on an instruction for an operation for the first ciphertext (Δ₁m). Δ₁m described in the parentheses of the ciphertext may indicate a decryption result corresponding to the ciphertext. The value described in the parentheses of the ciphertext does not indicate the ciphertext itself, and is merely a value for intuitively indicating the ciphertext. Regarding ciphertexts below, a format of a ciphertext (x) may also be described as a value for indicating the ciphertext in the same manner. A ciphertext itself may be described in a form of (a, b). As an example, a, b may mean a polynomial.

As an example, the at least one processor 110 may store the first ciphertext (Δ₁m) in the memory 120. The at least one processor 110 may obtain the first ciphertext (Δ₁m) from the memory 120.

The at least one processor 110 may receive the instruction for an operation for the first ciphertext (Δ₁m). When the instruction for an operation is received, the at least one processor 110 may identify the first ciphertext (Δ₁m) which becomes a subject for the operation.

The at least one processor 110 may execute the instruction for an operation for the first ciphertext (Δ₁m). In the first ciphertext (Δ₁m), the first scaling factor Δ1 and m may indicate data indicating at least one of a real number or a complex number. m may be an encrypted vector value. Also, m may indicate data (or a message) that is sought to be expressed by the ciphertext.

The scaling factor Δ may indicate a constant number that is multiplied for approximating data (or a message) of a real number or a complex number to an integer-valued polynomial and encrypting it. Also, the scaling factor Δ may be a constant number value that is multiplied for approximating a message in a real number form to an integer form. The scaling factor Δ may be used for adjusting the precision of expression within the ciphertext, and restoring the original real number value at the time of decryption.

The at least one processor 110 may obtain a second ciphertext (Δ₁m+e₁) including a noise e₁ based on an operation action (or an instruction for an operation). The noise e₁ that did not exist in the first ciphertext (Δ₁m) may be included in the second ciphertext (Δ₁m+e₁). In the operation process, noises may keep being generated.

Meanwhile, as the operation action is performed, the modulus of the ciphertext may decrease. The modulus may be a reference value that is used for limiting a size of a number in the operation action. The modulus may indicate a number that makes a calculation result expressed in the remaining form based on a specific value.

The at least one processor 110 may determine whether a predetermined event is identified based on the modulus q₁ of the second ciphertext (Δ₁m+e₁).

If the predetermined event is not identified based on the modulus q₁ of the second ciphertext (Δ₁m+e₁), the at least one processor 110 may keep performing the operation action.

If the predetermined event is identified based on the modulus q₁ of the second ciphertext (Δ₁m+e₁), the at least one processor 110 may perform bootstrapping.

The bootstrapping may mean an operation of increasing the modulus of the ciphertext. Also, the bootstrapping may indicate an operation of increasing the modulus while maintaining the original data Δ₁m in the ciphertext.

If the predetermined event is identified based on the modulus q₁ of the second ciphertext (Δ₁m+e₁), the at least one processor 110 may perform bootstrapping based on a first scaling factor Δ₁, a second scaling factor Δ₂, and a third scaling factor Δ₃ different from one another, and may thereby obtain an output ciphertext (Δ₁m+e₆) having a bigger modulus q₂ than the modulus q₁ of the second ciphertext (Δ₁m+e₁).

Each of the first scaling factor Δ₁, the second scaling factor Δ₂, and the third scaling factor Δ₃ may be different from one another.

The second scaling factor Δ₂ may be bigger than the third scaling factor Δ₃. If the scaling factor Δ increases, precision of a calculation may increase. Accordingly, in the case of using the second scaling factor Δ₂, a result of better precision may be obtained than in a case of using the third scaling factor Δ₃. However, in the case of using the second scaling factor Δ₂, a processing amount of an operation may be more than in a case of using the third scaling factor Δ₃.

The at least one processor 110 may obtain an output ciphertext (Δ₁m+e₆) by using the second scaling factor Δ₂ and the third scaling factor Δ₃ other than the first scaling factor Δ₁ used in the initial first ciphertext (Δ₁m). The output ciphertext may be described as an eighth ciphertext.

The at least one processor 110 may perform an additional operation action based on the output ciphertext (Δ₁m+e₆).

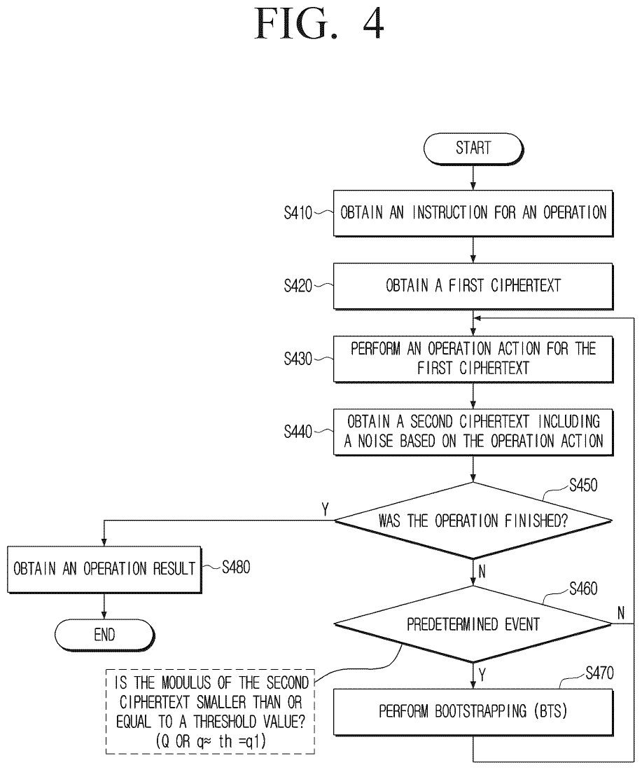

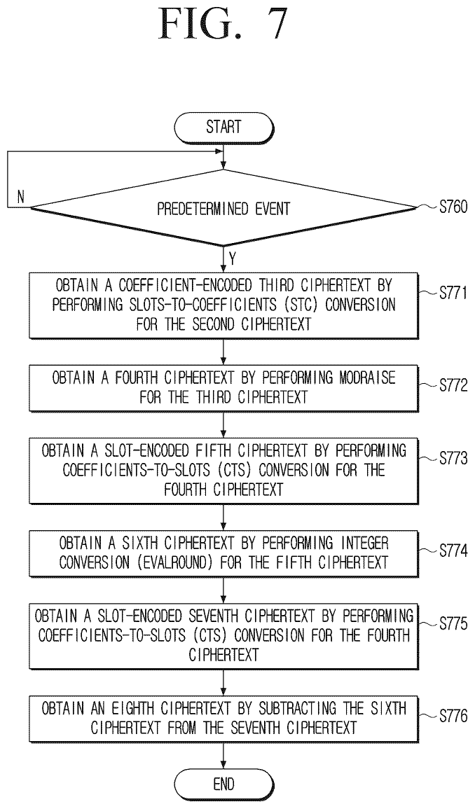

If the modulus q₁ of the second ciphertext (Δ₁m+e₁) is smaller than or equal to a threshold value, the at least one processor 110 may identify that the predetermined event occurred. Explanation in this regard will be described in the step S460 in FIG. 4 and the step S760 in FIG. 7.

The at least one processor 110 may obtain a coefficient-encoded third ciphertext (Δ₂m+e₂) by performing Slots-to-Coefficients (StC) conversion for the second ciphertext (Δ₁m+e₁) based on the second scaling factor Δ₂ different from the first scaling factor Δ₁. The at least one processor 110 may obtain the output ciphertext (Δ₁m+e₆) by performing modulus expansion for the third ciphertext (Δ₂m+e₂).

The at least one processor 110 may obtain a fourth ciphertext (q₀I+Δ₂m+e₂) by performing ModRaise of expanding the modulus for the third ciphertext (Δ₂m+e₂). The at least one processor 110 may obtain the output ciphertext (Δ₁m+e₆) based on the fourth ciphertext (q₀I+Δ₂m+e₂).

The at least one processor 110 may obtain a slot-encoded fifth ciphertext (Δ₃I+e₃) by performing first coefficients-to-slots (CtS) conversion for the fourth ciphertext (q₀I+Δ₂m+e₂) based on the third scaling factor Δ₃ smaller than the second scaling factor Δ₂.

The at least one processor 110 may obtain a sixth ciphertext (q₀I+e₄) by filtering a second portion other than a first portion indicating an integer in the fifth ciphertext (Δ₃I+e₃).

The at least one processor 110 may obtain an output ciphertext (Δ₁m+e₆) based on the sixth ciphertext (q₀I+e₄).

The at least one processor 110 may obtain a slot-encoded seventh ciphertext (q₀I+Δ₂m+e₅) by performing second coefficients-to-slots (CtS) conversion for the fourth ciphertext (q₀I+Δ₂m+e₂) based on the second scaling factor Δ₂.

The at least one processor 110 may obtain an output ciphertext (Δ₁m+e₆) based on the sixth ciphertext (q₀I+e₄) and the seventh ciphertext (q₀I+Δ₂m+e₅).

The at least one processor 110 may obtain an eighth ciphertext (Δ₁m+e₆) indicating the output ciphertext (Δ₁m+e₆) by subtracting the sixth ciphertext (q₀I+e₄) from the seventh ciphertext (q₀I+Δ₂m+e₅).

The at least one processor 110 may obtain the eighth ciphertext (Δ₁m+e₆) by using the first scaling factor Δ₁ instead of the second scaling factor Δ₂.

The at least one processor 110 may obtain a remining modulus q₂/q₁ based on a difference value between a modulus q₂ of the eighth ciphertext (Δ₁m+e₆) and a modulus q₁ of the second ciphertext (Δ₁m+e₁). The at least one processor 110 may perform an additional operation action based on the remaining modulus q₂/q₁.

The electronic apparatus 100 may perform an additional operation action as much as the remaining modulus q₂/q₁. The electronic apparatus 100 may determine that it is difficult to perform an operation action anymore at the modulus q₁ of the second ciphertext (Δ₁m+e₁). The electronic apparatus 100 may secure a modulus for an additional operation through a bootstrapping operation.

The electronic apparatus 100 may use a plurality of scaling factors A for performing a bootstrapping operation. The electronic apparatus 100 may use the third scaling factor Δ₃ which is relatively small only for some operations among a plurality of detailed operations included in the bootstrapping operation. Accordingly, the electronic apparatus 100 can improve the overall operation speed and operation efficiency.

FIG. 4 is a diagram for illustrating an operation of performing bootstrapping according to an embodiment.

Referring to FIG. 4, the electronic apparatus 100 may obtain an instruction for an operation in the step S410. The electronic apparatus 100 may obtain an instruction for an operation related to homomorphic encryption. The instruction for an operation may indicate an instruction for performing an operation related to homomorphic encryption.

The electronic apparatus 100 may obtain a first ciphertext in the step S420. The electronic apparatus 100 may obtain the first ciphertext which becomes a subject of the instruction for an operation.

The electronic apparatus 100 may perform an operation action for the first ciphertext in the step S430. The electronic apparatus 100 may obtain an operation action corresponding to the instruction for an operation. The electronic apparatus 100 may execute the instruction for an operation for the first ciphertext.

The electronic apparatus 100 may obtain a second ciphertext including a noise based on the operation action in the step S440. If an operation for homomorphic encryption is performed, a noise may be included in the operation result. The electronic apparatus 100 may obtain the second ciphertext including a noise as an operation result for the first ciphertext.

The electronic apparatus 100 may identify ending of the operation in the step S450. The electronic apparatus 100 may identify whether all operation actions corresponding to the instruction for an operation were completed.

If the operation action did not end in the step S450-N, the electronic apparatus 100 may identify whether a predetermined event occurred in the step S460.

As an example, the predetermined event may include an event wherein a modulus of a ciphertext of an operation result is smaller than or equal to a threshold value. For example, the predetermined event may include an event wherein the modulus of the second ciphertext is smaller than or equal to the threshold value. The threshold value may be changed according to the user's setting.

If the predetermined event is not identified in the step S460-N, the electronic apparatus 100 may repeat the steps S430, S440, S450, and S460.

If the predetermined event is identified in the step S460-Y, the electronic apparatus 100 may perform bootstrapping in the step S470. The electronic apparatus 100 may obtain a ciphertext wherein a modulus increased through bootstrapping. The electronic apparatus 100 may perform bootstrapping for securing a modulus.

In case an operation action using homomorphic encryption is performed, a modulus may decrease. In case a modulus decreases, an operation for homomorphic encryption may be impossible. Accordingly, the electronic apparatus 100 may perform bootstrapping for increasing the modulus. Bootstrapping may be an operation for securing a modulus. The electronic apparatus 100 may perform bootstrapping for securing a modulus.

When the bootstrapping operation is completed, the electronic apparatus 100 may repeat the steps S430, S440, S450, and S460.

If the operation action ended in the step S450-Y, the electronic apparatus 100 may obtain an operation result in the step S480. The electronic apparatus 100 may store the operation result in the memory 120.

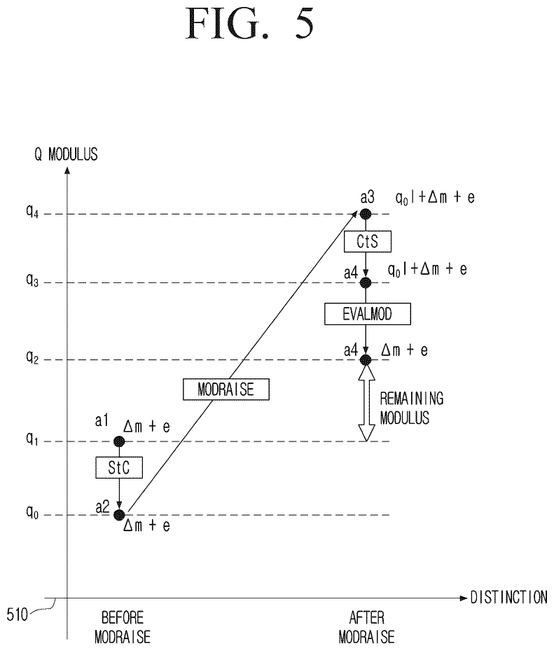

FIG. 5 is a diagram for illustrating an operation of increasing a modulus according to an embodiment.

Referring to the graph 510 in FIG. 5, the electronic apparatus 100 may perform bootstrapping for securing a modulus in homomorphic encryption.

The electronic apparatus 100 may obtain a ciphertext (Δm+e) wherein a modulus is q₁ as a result of an operation action for homomorphic encryption (a1). Δ may mean a scaling factor. m may mean an encrypted content. e may mean a noise.

The electronic apparatus 100 may obtain a coefficient-encoded ciphertext (Δm+e) wherein a modulus is q₀ by performing Slots-to-Coefficients (StC) conversion for the ciphertext (Δm+e) wherein a modulus is q₁ (a2).

The electronic apparatus 100 may increase the modulus by performing ModRaise (a3). The electronic apparatus 100 may obtain a ciphertext (q₀I+Δm+e) wherein a modulus is q₄ as a result of ModRaise.

The electronic apparatus 100 may obtain a slot-encoded ciphertext (q₀I+Δm+e) by performing coefficients-to-slots (CtS) conversion for the ciphertext (q₀I+Δm+e) wherein a modulus is q₄ (a4). The modulus of the slot-encoded ciphertext (q₀I+Δm+e) may be q₃.

The electronic apparatus 100 may perform EvalMod for the slot-encoded ciphertext (q₀I+Δm+e). The electronic apparatus 100 may obtain a ciphertext (Δm+e) wherein the integer was removed based on EvalMod (a5). The modulus of the ciphertext (Δm+e) wherein the integer was removed may be q₂.

The electronic apparatus 100 may ultimately obtain a ciphertext (Δm+e) wherein a modulus is q₂. The electronic apparatus 100 may increase the modulus from q₁ to q₂. The electronic apparatus 100 may perform an operation action for homomorphic encryption based on the ciphertext wherein the modulus increased.

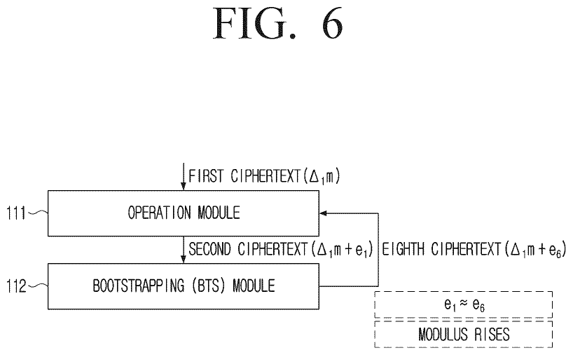

FIG. 6 is a diagram for illustrating an operation module and a bootstrapping module according to an embodiment.

Referring to FIG. 6, the electronic apparatus 100 may include an operation module 111 and a bootstrapping module 112.

The electronic apparatus 100 may be an apparatus that operates homomorphic encryption. The homomorphic encryption may indicate encryption wherein an operation is performed in an encrypted state. Also, the homomorphic encryption may indicate encryption wherein an addition or a multiplication is homomorphically performed regarding approximate values of a real number (or a complex number). The electronic apparatus 100 may perform an operation for the encrypted real number vector.

The operation module 111 may be a module that performs an operation action for homomorphic encryption. The operation module 111 may be a module that is constituted to perform a homomorphic operation (e.g.: an addition, a multiplication, etc.) for encrypted data. Also, the operation module 111 may be a module that is constituted to perform a homomorphic operation such as an addition, a multiplication, etc. between ciphertexts for processing data in an encrypted state without decryption.

The operation module 111 may perform an operation in a vector unit for a ciphertext which is a subject for the operation. If an operation action is performed by the operation module 111, a noise may be generated for the ciphertext which is a subject for the operation. Also, if an operation action is performed by the operation module 111, a modulus of the ciphertext which is a subject for the operation may decrease.

A modulus may indicate an integer coefficient that is used in an encryption operation or a decryption operation. Also, a modulus may be a reference value that is used for limiting a size of a number in an encryption operation. A modulus may indicate a number that makes a calculation result expressed in the remaining form based on a specific value.

A modulus may be a mathematical parameter that is used for suppressing increase of noises and maintaining the precision of a ciphertext in a homomorphic operation by controlling such that a coefficient within the ciphertext does not exceed a specific range.

In a homomorphic encryption operation, a rescale operation is performed for maintaining the precision after a multiplication, and a modulus should be divided into smaller moduli in this process, and thus the modulus may gradually decrease in the operation process. If the modulus becomes too small, a noise included in a ciphertext becomes similar to the size of the modulus, and thus it may become difficult to distinguish the original message.

The electronic apparatus 100 needs to increase a modulus of a ciphertext for performing an operation action for the ciphertext. The electronic apparatus 100 may perform bootstrapping for increase of the modulus.

The electronic apparatus 100 may receive an instruction for an operation. The electronic apparatus 100 may execute an instruction for an operation for the first ciphertext (Δ₁m). The electronic apparatus 100 may input the first ciphertext (Δ₁m) into the operation module 111.

The operation module 111 may perform an operation action for the first ciphertext (Δ₁m). The operation module 111 may obtain a second ciphertext (Δ₁m+e₁) as an operation result for the first ciphertext (Δ₁m).

In case it is determined that bootstrapping is needed, the electronic apparatus 100 may transmit a ciphertext to the bootstrapping module 112. The electronic apparatus 100 may transmit the second ciphertext (Δ₁m+e₁) output from the operation module 111 to the bootstrapping module 112.

The bootstrapping module 112 may be a module that performs a bootstrapping operation for a ciphertext which becomes a subject for an operation of homomorphic encryption.

According to an embodiment, the bootstrapping module 112 may increase a modulus.

The bootstrapping module 112 may obtain an eighth ciphertext (Δ₁m+e₆) wherein a modulus was increased. The modulus of the eighth ciphertext (Δ₁m+e₆) may be bigger than the modulus of the second ciphertext (Δ₁m+e₁). The eighth ciphertext (Δ₁m+e₆) wherein the modulus was increased may be used in an operation action again. The noise e7 included in the eighth ciphertext (Δ₁m+e₆) and the noise e1 included in the second ciphertext (Δ₁m+e₁) may be different. The difference of the noises may be an approximate value compared to the ciphertexts.

The bootstrapping module 112 may transmit the eighth ciphertext (Δ₁m+e₆) to the operation module 111. The operation module 111 may perform an operation action based on the received eighth ciphertext (Δ₁m+e₆).

According to an embodiment, the bootstrapping module 112 may be a module that was constituted to decrease a noise that increased in a process of performing a homomorphic operation, and thereby re-process a ciphertext such that the precision of the ciphertext is restored and an additional operation is possible.

FIG. 7 is a diagram for illustrating an operation of obtaining a ciphertext wherein a modulus was increased according to an embodiment.

The step S760 in FIG. 7 may correspond to the step S460 in FIG. 4. The operations in FIG. 4 may be applied identically to the embodiment in FIG. 7. The electronic apparatus 100 may identify whether a predetermined occurred in the step S760.

As an example, the predetermined event may include an event wherein a modulus of a ciphertext obtained as an operation result is smaller than or equal to a threshold value. For example, the predetermined event may include an event wherein a modulus of the second ciphertext is smaller than or equal to the threshold value. The threshold value may be changed according to the user's setting.

If the predetermined event is identified in the step S760-Y, the electronic apparatus 100 may obtain a coefficient-encoded third ciphertext (Δ₂m+e₂) by performing Slots-to-Coefficients (StC) conversion for the second ciphertext (Δ₁m+e₁) in the step S771. The Slots-to-Coefficients (StC) conversion may indicate an operation of converting a ciphertext encoded in a form of a slot into a form of a polynomial coefficient.

The electronic apparatus 100 may obtain a fourth ciphertext (q₀I+Δ₂m+e₂) by performing ModRaise for the third ciphertext (Δ₂m+e₂) in the step S772. The ModRaise may indicate an operation of converting a ciphertext using a low modulus into a ciphertext using a higher modulus. In case ModRaise is performed, the original message may be maintained in the ciphertext, but an additional integer polynomial term may be added.

The electronic apparatus 100 may obtain a slot-encoded fifth ciphertext (Δ₃I+e₃) by performing coefficients-to-slots (CtS) conversion for the fourth ciphertext (q₀I+Δ₂m+e₂) in the step S773. The coefficients-to-slots (CtS) conversion may indicate an operation of converting a ciphertext encoded in a form of a polynomial coefficient into a slot form in a form of a complex number vector.

The electronic apparatus 100 may obtain a sixth ciphertext (q₀I+e₄) by performing integer conversion (EvalRound) for the fifth ciphertext (Δ₃I+e₃) in the step S774. The integer conversion may indicate conversion wherein filtering (or cleaning) is performed such that only an integer polynomial remains in an integer polynomial including a noise. The electronic apparatus 100 may remove the other decimal parts through integer conversion such that the q0I portion included in the ciphertext remains.

The electronic apparatus 100 may obtain a slot-encoded seventh ciphertext (q₀I+Δ₂m+e₅) by performing coefficients-to-slots (CtS) conversion for the fourth ciphertext (q₀I+Δ₂m+e₂) in the step S775.

The electronic apparatus 100 may obtain an eighth ciphertext (Δ₁m+e₆) by subtracting the sixth ciphertext (q₀I+e₄) from the seventh ciphertext (q₀I+Δ₂m+e₅) in the step S776. The noise e₆ included in the eighth ciphertext (Δ₁m+e₆) and the noise e₂ included in the second ciphertext (Δ₁m+e₁) may be different. However, the modulus of the eighth ciphertext (Δ₁m+e₆) may be bigger than the modulus of the second ciphertext (Δ₁m+e₁). Accordingly, the electronic apparatus 100 may perform an additional operation by using the eighth ciphertext (Δ₁m+e₆) having an expanded modulus.

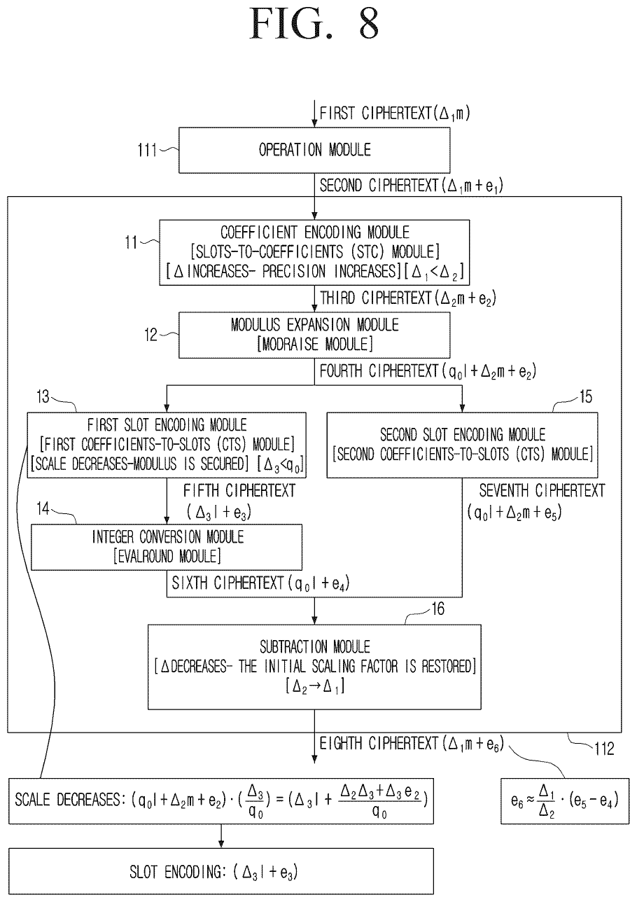

FIG. 8 is a diagram for illustrating a bootstrapping module according to an embodiment.

Referring to FIG. 8, the electronic apparatus 100 may include an operation module 111 and a bootstrapping module 112. The bootstrapping module 112 may include at least one of a coefficient encoding module 11, a modulus expansion module 12, a first slot encoding module 13, an integer conversion module 14, a second slot encoding module 15, or a subtraction module 16.

The electronic apparatus 100 may obtain an instruction for an operation. The electronic apparatus 100 may obtain a first ciphertext (Δ₁m) which is a subject for the instruction for an operation. The electronic apparatus 100 may input the first ciphertext (Δ₁m) into the operation module 111 as input data. The operation module 111 may perform a predetermined operation action for the first ciphertext (Δ₁m). The operation action may include performing a predetermined operation algorithm related to homomorphic encryption. The operation module 111 may obtain a second ciphertext (Δ₁m+e₁) as output data as the operation result. The operation module 111 may transmit the second ciphertext (Δ₁m+e₁) to the bootstrapping module 112.

The bootstrapping module 112 may transmit the second ciphertext (Δ₁m+e₁) transmitted by the operation module 111 to the coefficient encoding module 11.

The coefficient encoding module 11 may be a module that performs Slots-to-Coefficients (StC) conversion. Also, the coefficient encoding module 11 may be a module that converts a ciphertext encoded in a form of a slot into a form of a polynomial coefficient.

The coefficient encoding module 11 may receive the second ciphertext (Δ₁m+e₁). The coefficient encoding module 11 may obtain a third ciphertext (Δ₂m+e₂) as output data by performing StC conversion for the second ciphertext (Δ₁m+e₁). The coefficient encoding module 11 may transmit the third ciphertext (Δ₂m+e₂) to the modulus expansion module 12.

The coefficient encoding module 11 may change the scaling factor Δ while performing StC conversion. The coefficient encoding module 11 may change the first scaling factor Δ₁ to the second scaling factor Δ₁. The second scaling factor Δ₂ may be a bigger value than the first scaling factor Δ₁. If the scaling factor Δ increases, the precision of a calculation may increase.

The noise e₁ included in the second ciphertext (Δ₁m+e₁) and the noise e₂ included in the third ciphertext (Δ₂m+e₂) may be different.

The modulus expansion module 12 may be a module that expands a modulus consumed in a calculation process. The modulus expansion module 12 may perform an operation of increasing a range (=a modulus) of numbers used in a ciphertext to be bigger. The modulus expansion module 12 may perform an operation of adding a value q₀I which is a result of multiplying a modulus q₀ by a polynomial I. The operation of expanding a modulus may be described as an operation of performing ModRaise.

The modulus expansion module 12 may receive a third ciphertext (Δ₂m+e₂) from the coefficient encoding module 11. The modulus expansion module 12 may obtain a fourth ciphertext (q₀I+Δ₂m+e₂) by adding the value q₀I which is a result of multiplying the modulus q₀ by the polynomial I to the third ciphertext (Δ₂m+e₂). The modulus expansion module 12 may transmit the fourth ciphertext (q₀I+Δ₂m+e₂) to the first slot encoding module 13. The modulus expansion module 12 may transmit the fourth ciphertext (q₀I+Δ₂m+e₂) to the second slot encoding module 15.

The noise e2 included in the third ciphertext (Δ₂m+e₂) and the noise e2 included in the fourth ciphertext (q₀I+Δ₂m+e₂) may be identical.

The first slot encoding module 13 may be a module that performs coefficients-to-slots (CtS) conversion. Also, the first slot encoding module 13 may be a module that performs an operation of converting a ciphertext encoded in a form of a polynomial coefficient into a slot form in a form of a complex number vector.

The first slot encoding module 13 may receive the fourth ciphertext (q₀I+Δ₂m+e₂) from the modulus expansion module 12. The first slot encoding module 13 may obtain a fifth ciphertext (Δ₃I+e₃) encoded in a slot form by performing CtS conversion for the fourth ciphertext (q₀I+Δ₂m+e₂). The first slot encoding module 13 may transmit the fifth ciphertext (Δ₃I+e₃) to the integer conversion module 14.

The first slot encoding module 13 may decrease the scaling factor Δ. The first slot encoding module 13 may change the second scaling factor Δ₂ to the third scaling factor Δ₃ while performing CtS conversion. The third scaling factor Δ₃ may be a smaller value than the second scaling factor Δ₂.

The first slot encoding module 13 may perform a scale decreasing operation and a slot encoding operation. The scale decreasing operation may indicate an operation of multiplying the fourth ciphertext (q₀I+Δ₂m+e₂) by Δ₃/q₀. The first slot encoding module 13 may obtain

$$( {Δ}_{3} I + \frac{{Δ}_{2} {Δ}_{3} \cdot m + {Δ}_{3} {e}_{2}}{{q}_{0}} )$$

by the scale decreasing operation. Here, Δ₃ may be smaller than q₀. Accordingly, Δ₃/q₀ may have a value smaller than 1. The fourth ciphertext may be a form wherein I was multiplied by q₀, but the fifth ciphertext may be a form wherein I was multiplied by Δ₃. Accordingly, the scaling factor may decrease from q₀ to Δ₃ based on I. The first slot encoding module 13 may secure a modulus through scale decrease.

The first slot encoding module 13 may perform slot encoding for the result value regarding the scale decrease. The first slot encoding module 13 may obtain a fifth ciphertext (Δ₃I+e₃) by performing CtS conversion for

$$( {Δ}_{3} I + \frac{{Δ}_{2} {Δ}_{3} \cdot m + {Δ}_{3} {e}_{2}}{{q}_{0}} ) .$$

The noise e2 included in the fourth ciphertext (q₀I+Δ₂m+e₂) and the noise e3 included in the fifth ciphertext (Δ₃I+e₃) may be different.

The integer conversion module 14 may be a module that performs filtering (or cleaning) such that only an integer polynomial remains in an integer polynomial including a noise. The integer conversion module 14 may be described as an EvalRound module. The integer conversion module 14 may be described as a filtering module.

The integer conversion module 14 may receive the fifth ciphertext (Δ₃I+e₃) from the first slot encoding module 13. The integer conversion module 14 may obtain a sixth ciphertext (q₀I+e₄) as output data by performing a filtering (or cleaning) operation for excluding parts that are not an integer in the fifth ciphertext (Δ₃I+e₃). The integer conversion module 14 may transmit the sixth ciphertext (q₀I+e₄) to the subtraction module 16.

In the fifth ciphertext (Δ₃I+e₃), data corresponding to the integer part may be q0I. Also, in the fifth ciphertext (Δ₃I+e₃), data corresponding to parts that are not an integer may be Δ₃m+e₃. The integer conversion module 14 may remove the data corresponding to the parts that are not an integer (Δ₃m+e₃) in the fifth ciphertext (Δ₃I+e₃). A noise may be generated in the removing operation. Accordingly, the sixth ciphertext (q₀I+e₄) may include a noise e4.

The noise e3 included in the fifth ciphertext (Δ₃I+e₃) and the noise e4 included in the sixth ciphertext (q₀I+e₄) may be different.

The second slot encoding module 15 may be a module that performs coefficients-to-slots (CtS) conversion. Also, the second slot encoding module 15 may be a module that performs an operation of converting a ciphertext encoded in a form of a polynomial coefficient into a slot form in a form of a complex number vector.

The difference between the second slot encoding module 15 and the first slot encoding module 13 may be whether the scaling factor Δ is changed. It was described that the first slot encoding module 13 changes the scaling factor Δ. However, the second slot encoding module 15 may maintain the scaling factor Δ. The second slot encoding module 15 may output a slot-encoded ciphertext without changing the scaling factor Δ.

The second slot encoding module 15 may receive the fourth ciphertext (q₀I+Δ₂m+e₂) from the modulus expansion module 12. The second slot encoding module 15 may obtain a slot-encoded seventh ciphertext (q₀I+Δ₂m+e₅) as output data.

The scaling factor Δ₂ of the fourth ciphertext (q₀I+Δ₂m+e₂) and the scaling factor Δ₂ of the seventh ciphertext (q₀I+Δ₂m+e₅) may be identical.

The noise e₂ of the fourth ciphertext (q₀I+Δ₂m+e₂) and the noise e₅ of the seventh ciphertext (q₀I+Δ₂m+e₅) may be different.

The subtraction module 16 may be a module for outputting a ciphertext wherein a modulus increased. Also, the subtraction module 16 may be a module that generates output data wherein a modulus of the input data was increased.

The subtraction module 16 may receive the sixth ciphertext (q₀I+e₄) from the integer conversion module 14. The subtraction module 16 may receive the seventh ciphertext (q₀I+Δ₂m+e₅) from the second slot encoding module 15. The subtraction module 16 may obtain an eighth ciphertext (Δ₁m+e₆) by subtracting the sixth ciphertext (q₀I+e₄) from the seventh ciphertext (q₀I+Δ₂m+e₅).

The subtraction module 16 may remove a value q₀I which is a result of multiplying a modulus q₀ added by the modulus expansion module 12 by a polynomial I.

The subtraction module 16 may change the scaling factor Δ. The subtraction module 16 may generate output data by the scaling factor Δ₁ identical to the scaling factor Δ₁ of the second ciphertext (Δ₁m+e₁) which is input data received by the bootstrapping module 112.

The scaling factor Δ₁ of the eighth ciphertext (Δ₁m+e₆) may be identical to the scaling factor Δ₁ of the second ciphertext (Δ₁m+e₁).

The noise e6 of the eighth ciphertext (Δ₁m+e₆) may be different from the noise e4 of the sixth ciphertext (q₀I+e₄).

The noise e6 of the eighth ciphertext (Δ₁m+e₆) may be different from the noise e5 of the seventh ciphertext (q₀I+Δ₂m+e₅).

The noise of the eighth ciphertext (Δ₁m+e₆) may be

$$\frac{{Δ}_{1}}{{Δ}_{2}} \cdot ( {e}_{5} - {e}_{4} ) .$$

The modulus of the eighth ciphertext (Δ₁m+e₆) may be a bigger value than the modulus of the second ciphertext (Δ₁m+e₁). The electronic apparatus 100 may perform an additional operation action based on the eight ciphertext (Δ₁m+e₆) corresponding to the increased modulus.

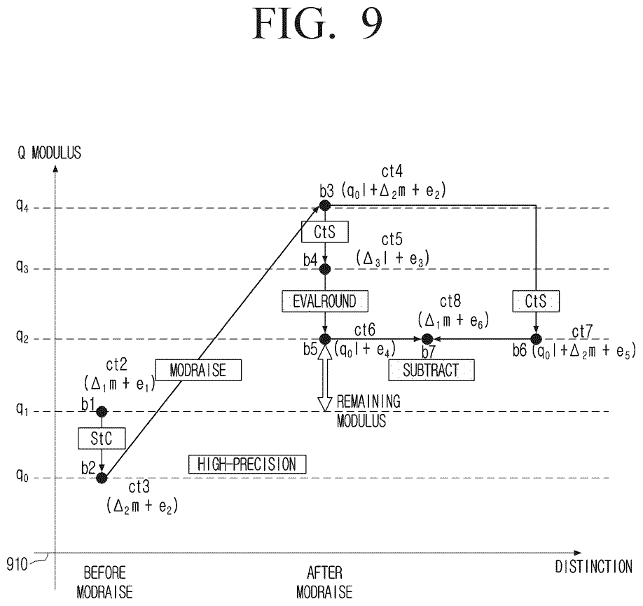

FIG. 9 is a diagram for illustrating a change of a modulus in a bootstrapping operation according to an embodiment.

Referring to the graph 910 in FIG. 9, the electronic apparatus 100 may perform bootstrapping for securing a modulus in homomorphic encryption.

The electronic apparatus 100 may obtain a second ciphertext (Δ₁m+e₁) corresponding to a modulus q1 as a result of the operation action for homomorphic encryption (b1). The electronic apparatus 100 may determine that it is difficult for the modulus q1 to perform an additional operation action. The electronic apparatus 100 may perform a bootstrapping operation for increasing the modulus.

The electronic apparatus 100 may obtain a third ciphertext (Δ₂m+e₂) by performing StC conversion for the second ciphertext (Δ₁m+e₁) (b2). The modulus q0 of the third ciphertext (Δ₂m+e₂) may be a smaller value than the modulus q1 of the second ciphertext (Δ₁m+e₁).

The electronic apparatus 100 may expand the modulus q₀ of the third ciphertext (Δ₂m+e₂). The electronic apparatus 100 may obtain a fourth ciphertext (q₀I+Δ₂m+e₂) by adding a value q₀I which is a result of multiplying the modulus q₀ with a polynomial I (b3). The modulus q₄ of the fourth ciphertext (q₀I+Δ₂m+e₂) may be a bigger value than the modulus q₀ of the third ciphertext (Δ₂m+e₂).

The electronic apparatus 100 may obtain a fifth ciphertext (Δ₃I+e₃) by performing CtS conversion for the fourth ciphertext (q₀I+Δ₂m+e₂) (b4). The modulus q₃ of the fifth ciphertext (Δ₃I+e₃) may be a smaller value than the modulus q₄ of the fourth ciphertext (q₀I+Δ₂m+e₂).

The electronic apparatus 100 may obtain a sixth ciphertext (q₀I+e₄) by performing integer conversion for the fifth ciphertext (Δ₃I+e₃) (b5). The modulus q₂ of the sixth ciphertext (q₀I+e₄) may be a smaller value than the modulus q3 of the fifth ciphertext (43I+e₃).

The electronic apparatus 100 may obtain a seventh ciphertext (q₀I+Δ₂m+e₅) by performing CtS conversion for the fourth ciphertext (q₀I+Δ₂m+e₂) (b6). The modulus q₂ of the seventh ciphertext (q₀I+Δ₂m+e₅) may be a smaller value than the modulus q₄ of the fourth ciphertext (q₀I+Δ₂m+e₂). Also, the modulus q₂ of the seventh ciphertext (q₀I+Δ₂m+e₅) may be a smaller value than the modulus q3 of the fifth ciphertext (Δ₃I+e₃). Further, the modulus q₂ of the seventh ciphertext (q₀I+Δ₂m+e₅) may be an identical value to the modulus q2 of the sixth ciphertext (q₀I+e₄).

The electronic apparatus 100 may obtain an eight ciphertext (Δ₁m+e₆) by performing a subtracting operation for the sixth ciphertext (q₀I+e₄) and the seventh ciphertext (q₀I+Δ₂m+e₅) (b7). The modulus q₂ of the eight ciphertext (Δ₁m+e₆) may be an identical value to the modulus q2 of the sixth ciphertext (q₀I+e₄). Also, the modulus q₂ of the eight ciphertext (Δ₁m+e₆) may be an identical value to the modulus q2 of the seventh ciphertext (q₀I+Δ₂m+e₅).

The electronic apparatus 100 may obtain an eight ciphertext (Δ₁m+e₆) having a bigger modulus q2 than the modulus q1 of the second ciphertext (Δ₁m+e₁) which is the initial input data. The electronic apparatus 100 may secure a modulus as much as the difference of the moduli (q₂/q₁). The electronic apparatus 100 may use the secured modulus as the remaining modulus. The electronic apparatus 100 may perform an additional operation action as much as the remaining modulus.

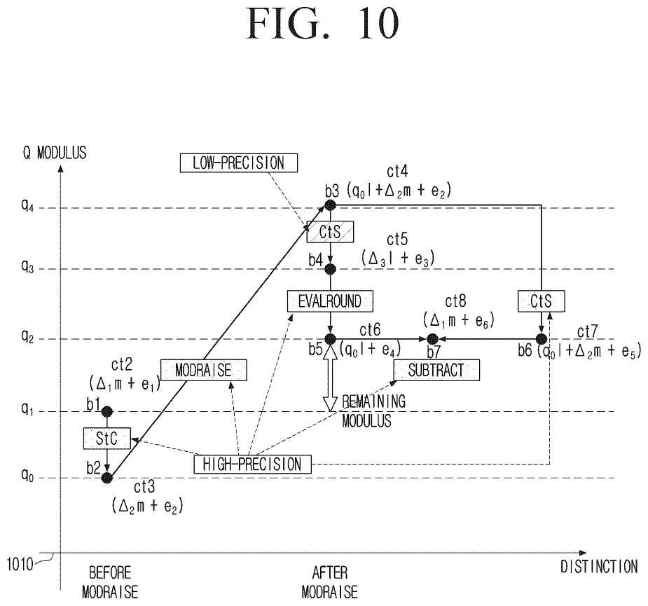

FIG. 10 is a diagram for illustrating an operation of controlling precision in a bootstrapping operation according to an embodiment.

The graph 1010 in FIG. 10 may correspond to the graph 910 in FIG. 9. Accordingly, overlapping explanation will be omitted.

The electronic apparatus 100 may obtain a fifth ciphertext (Δ₃I+e₃) by performing CtS conversion for the fourth ciphertext (q₀I+Δ₂m+e₂). The CtS conversion performed in this process may be described as first CtS conversion.

The electronic apparatus 100 may obtain a seventh ciphertext (q₀I+Δ₂m+e₅) by performing CtS conversion for the fourth ciphertext (q₀I+Δ₂m+e₂). The CtS conversion performed in this process may be described as second CtS conversion.

The electronic apparatus 100 may obtain the second ciphertext (Δ₁m+e₁) using the first scaling factor Δ₁.

The electronic apparatus 100 may use the second scaling factor Δ₂ for an StC converting operation, a modulus securing operation (ModRaise), an integer converting operation (EvalRound), a second CtS converting operation, and a subtracting operation in performing a bootstrapping operation.

The second scaling factor Δ₂ may be bigger than the first scaling factor Δ₁.

The electronic apparatus 100 may use the third scaling factor Δ₃ for the first CtS conversion.

The third scaling factor Δ₃ may be smaller than the second scaling factor Δ₂.

As the scaling factor Δ is bigger, operation complexity may increase. Accordingly, as the scaling factor Δ is bigger, precision (or accuracy) may increase.

The electronic apparatus 100 may use the third scaling factor Δ₃ which is relatively low only for the first CtS converting operation. In the case of using a relatively low scaling factor Δ, modulus consumption is reduced, and thus efficiency can be improved. Also, as a modulus is consumed less, the remaining modulus can be secured relatively more. Accordingly, the overall operation efficiency can be improved.

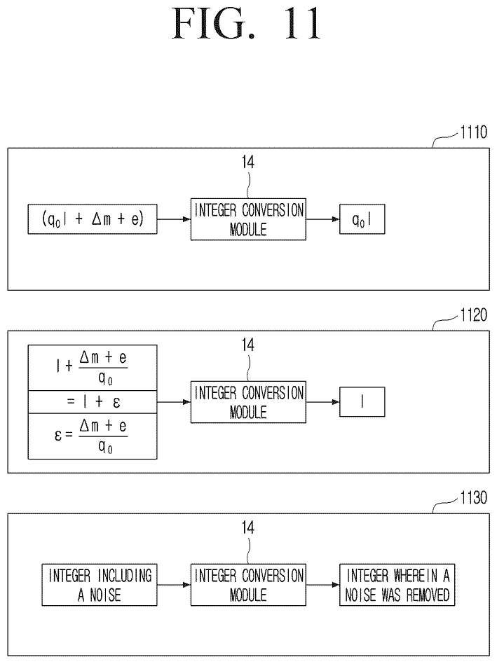

FIG. 11 is a diagram for illustrating an operation of converting an integer according to an embodiment.

Referring to the embodiment 1110 in FIG. 11, the electronic apparatus 100 may filter a second portion (Δm+e) but not the first portion (q₀l) indicating an integer in the ciphertext (q₀I+Δm+e) through the integer conversion module 14.

Referring to the embodiment 1120 in FIG. 11, the electronic apparatus 100 may filter a second portion

$$( \frac{Δ \cdot m + e}{{q}_{0}} )$$

but not the first portion (I) indicating an integer in the ciphertext

$$( I + \frac{Δ \cdot m + e}{{q}_{0}} )$$

through the integer conversion module 14.

Referring to the embodiment 1130 in FIG. 11, the electronic apparatus 100 may obtain an integer wherein a noise was removed based on an integer including a noise through the integer conversion module 14.

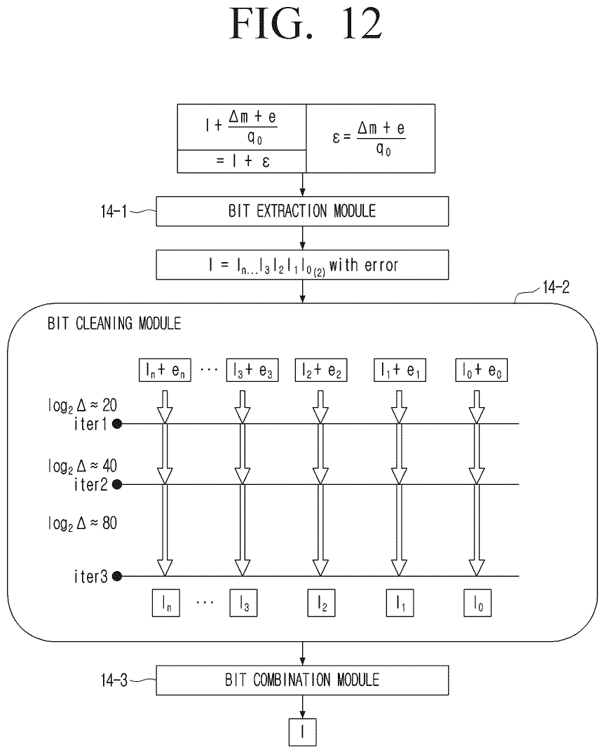

FIG. 12 is a diagram for illustrating a bit cleaning operation according to an embodiment.

Referring to FIG. 12, the integer conversion module 14 may include at least one of a bit extraction module 14-1, a bit extraction module 14-1, or a bit combination module 14-3.

The bit extraction module 14-1 may be a module that extracts a unit bit for a portion (I) indicating an integer in a ciphertext. Also, the bit extraction module 14-1 may be a module that extracts an integer value included in a ciphertext by dividing it into several small bit units (0 or 1). In the extracted unit bits, a noise may be included.

The bit extraction module 14-1 may perform a function of decomposing each coefficient of an integer polynomial included in a ciphertext in a form of a binary number, and separating each bit in a form of a ciphertext in this process and outputting them.

The bit cleaning module 14-2 may be a module that decreases noises (errors) mixed in extracted bits and organizes them to clean 0 or 1. The organizing operation may be repeated a plurality of times. In FIG. 12, it was described that three organizing operations are performed.

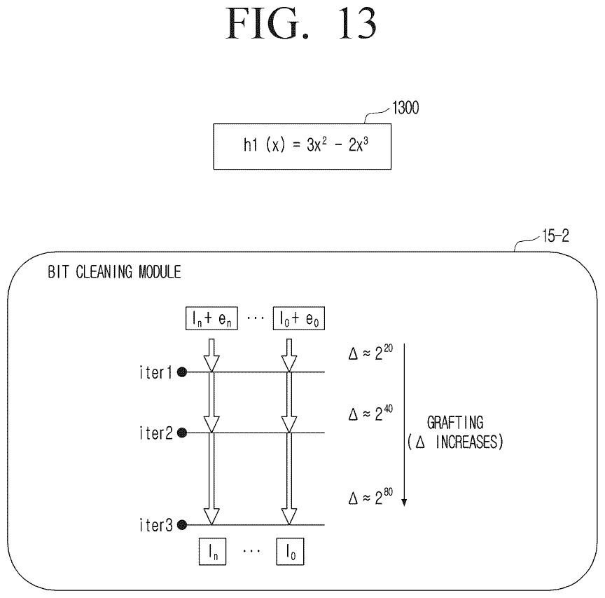

The bit cleaning module 14-2 may perform a function of organizing such that each bit becomes a value closer to 0 or 1 by using a purifying (cleaning) polynomial defined in advance for removing or reducing noises included in each extracted bit. A purifying polynomial will be described in FIG. 13.

The bit combination module 14-3 may be a module that puts together several organized bits again and makes them into one integer value. The bit combination module 14-3 may perform a function of combining purified bits into one integer polynomial again.

FIG. 13 is a diagram for illustrating a bit cleaning operation according to an embodiment.

The formula 1300 in FIG. 13 may indicate a purifying polynomial used in the bit cleaning module 14-2. A purifying polynomial may indicate a function that corrects an input value (x) to be close to 0 or 1 in case it is close to 0 or 1. A purifying polynomial may be, for example, a function for correcting a number such as 0.001 or 0.999 to 0 or 1.

As an example, the purifying polynomial may be h1(x)=3x²−2x³.

Whenever a purifying operation performed in the bit cleaning module 14-2 is repeatedly performed, the scaling factor Δ may increase.

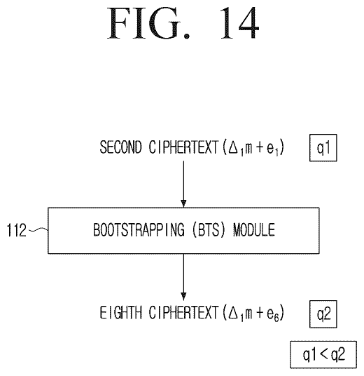

FIG. 14 is a diagram for illustrating a bootstrapping operation according to an embodiment.

Referring to FIG. 14, the electronic apparatus 100 may increase a modulus through the bootstrapping module 112. The bootstrapping module 112 may output an eighth ciphertext (Δ₁m+e₆) of a second modulus q2 based on a second ciphertext (Δ₁m+e₁) of a first modulus q1. The second modulus q2 may be bigger than the first modulus q1.

### 1 Introduction

The Cheon-Kim-Kim-Song (CKKS) [CKKS17] is one of the most popular Fully Homomorphic Encryption (FHE) schemes specialized for real number arithmetic. As Threshold-FHE [AJLA+12, BGG+18, MTPBH21] and IND-CPAD security [LM21, LMSS22] require CKKS to be sufficiently precise so that it affords Noise Flooding (i.e. the only solution), constructing high precision CKKS has become an important problem.

Supporting basic ingredients of CKKS up to homomorphic multiplication with high precision is relatively well studied. For instance, one may decompose the rescaling modulus into multiple primes [AAB+23], or maintain a tuple that approximately decomposes a real number [CCKS23]. The difficult part is high precision bootstrapping, as every underlying component should be handled accordingly. Many previous works relied on increasing precision of individual components [LLK+22, JM22], whereas the most recent work proposed an iterative method to increase the precision via repetitions [BCC+22].

Although the state-of-the-art methods support arbitrary precision bootstrapping with affordable running time, its performance still needs to be improved greatly. For instance, in order to achieve 200 bit precision CKKS bootstrapping, the current state-of-the-art uses [BCC+22] with ≈10 iterations and takes ≈100 seconds. In this paper, we propose a novel bootstrapping method that greatly improves the performance of high precision CKKS bootstrapping.

### 1.1: Technical Overview

At a high level, we observe that the ModRaise step of CKKS bootstrapping adds a large discrete noise to a given message. To be precise, let Δ·m∈ [symbol] q₀ be an input plaintext of ModRaise, then the output can be represented as Δ·m+q₀·I∈ [symbol] where I is a small integer polynomial. The key observation is that the ciphertext encrypting Δ·m+q₀·I can be regarded as a valid encryption of I with a scaling factor q0. The main advantage of dealing with discrete data is that we can use interpolation rather than approximation, following the philosophy of discrete variant of CKKS [DMPS24, CKKL24, BCKS24]. We illustrate the step-by-step algorithm as follows.
1. Coefficients-to-Slots: As the small integer polynomial I is in the coefficients, we use CtS to put it in slots.
2. Bit Decomposition: By using the fact that I is small, we decompose it into a few bits, which allows us to clean more easily.
3. Cleaning: We extract the clean bits of I following the cleaning framework in [DMPS24].
4. Recombination: We recombine the bits into an integer that represents I.
5. Slots-to-Coefficients: We put I back into coefficients, resulting in an encryption of q₀·I in coeffs.
6. Subtraction: We subtract q0·I from the original Δ·m+q₀·I, getting Δ·m as desired.

### 1.2: Related Works Algorithms

CKKS [CKKS17, CHK+18]
High Precision CKKS [AAB+23, CCKS23]
High Precision Bootstrapping: [LLK+22, JM22, BCC+22]
Discrete Bootstrapping [BCKS24, BKSS24, BGGJ20]
Discrete CKKS [DMPS24, CKKL24]
EvalRound [KPK+22]
General Bootstrapping [KDE+24, MHWW24, LW24]

### Applications

IND-CPAD [LM21, LMSS22]
Threshold-FHE [BGG+18, MTPBH21, AJLA+12]
BFV BTS from CKKS [KSS24]

### 2: Preliminaries

Let N>1 be a power-of-two integer and [symbol] = [symbol] [X]/(X^{N}+1). Given an integer q>1, let [symbol] q= [symbol] /q

[symbol]

### 2.1: CKKS Basics

The CKKS scheme relies on the Ring Learning With Errors (RLWE) problem for its encryption, and has a specific encoding structure that supports SIMD computation over reals. The discrete Fourier transform (DFT) denoted as DFT:

[symbol] [X]/(X^{N}+1)→ [symbol] ^{N/2} is defined as

$$DFT ( p ( X ) ) = {( p ( {ζ}^{{5}^{i}} ) )}_{0 \leq i < N / 2}$$

where ζ∈ [symbol] is a primitive 2N-th root of unity. The encoding map Ecd: [symbol] ^{N/2}→ [symbol] is defined as

$$Ecd ( z ) = ⌊ Δ \cdot iDFT ( z ) ⌉$$

where iDFT is an inverse of DFT and Δ>0 is a scaling factor. As DFT is a ring homomorphism, the encoding map enables SIMD computation over complex plane. To be more specific, the homomorphic operations in CKKS (defined over [symbol] ^{N/2}) include element wise addition/multiplication/conjugation and rotation across vector slots.

The conventional CKKS bootstrapping includes four steps, namely ModRaise, CtS, EvalMod, and StC.

(1) ModRaise: The modulus raising (ModRaise) simply regards a ciphertext (encrypting m∈ [symbol] ) at the bottom modulus q0 as a ciphertext without modulus. Assuming that the input ciphertext is properly normalized (so that its coefficients belong to [−q₀/2, q₀/2), the result of the modulus raising encrypts m+q₀·I for some small I∈ [symbol] .

(2) CtS and StC: The coefficients-to-slots (CtS) (resp. slots-to-coefficients (StC)) homomorphically evaluates iDFT (resp. DFT) so that a coefficients encoded ciphertext can be converted into a slots-encoded ciphertext (resp. vice versa). We need these steps because ModRaise is compatible with the coefficients encoding while EvalMod is compatible with the slots-encoding.

(3) EvalMod: The homomorphic modular reduction (EvalMod) homomorphically evaluates a modular reduction function. A typical approach is to use a polynomial approximation of the modular reduction function.

### 2.2: Discrete CKKS

In [DMPS24], they proposed an interesting approach to limit the message space: we only focus on a discrete subset [symbol] ^{N/2}⊂ [symbol] ^{N/2}. Such approach allows to handle discrete data with CKKS, and complex (e.g. non-continuous) functions can be handled with interpolation, not approximation. In order to keep the size of deviation from integer points, they introduce a framework called “cleaning”, which reduces such errors with simple polynomials. For instance, h₁(x)=3x²−2x³ can serve as a cleaning function for the bit encoding {0, 1}⊂ [symbol] , as h₁(1)=1,

$${h}_{1}^{′} ( 0 ) = {h}_{1}^{′} ( 1 ) = 0 ,$$

and. In [CKKL24], they further improved the discrete function evaluation strategy (i.e. look-up table or LUT) in [DMPS24] using multivariate interpolation over roots of unity. The multivariate interpolation allows us to reduce the multiplicative depth consumption while the use of roots of unity improves the throughput.

The other lines of works on discrete CKKS is to adapt the CKKS bootstrapping for discrete data computation. In [BCKS24], they encoded the bits in the most significant bits and found a more efficient bootstrapping that exploits the encoding structure. In addition, they proposed an analogue of gate bootstrapping in the context of TFHE [CGGI16] and FHEW [DM15], evaluating gates during bootstrapping. In [BKSS24], they extended the bit bootstrapping to small integers, providing either a functional bootstrapping or parallelization of bit bootstrapping.

### 3: Main Algorithms

The main framework of this paper is to somehow extract the discrete CKKS ciphertext from the approximate CKKS ciphertext and bootstrap only the discrete one, achieving the bootstrapping of the original ciphertext. Here we follow the discrete bootstrapping framework in [BKSS24], while the extraction methods are based on either [KDE+24] or [KPK+22].

### 3.1: Based on [KDE+24]

The bootstrapping method in [KDE+24] extracts the small integer polynomial using modulus switching. They then use the TFHE/FHEW bootstrapping to bootstrap the extracted polynomial. We observe that the extracted small integer polynomial can be regarded as a valid discrete CKKS ciphertext, and we bootstrap it using the bootstrapping framework in [BKSS24].

The algorithm (described in Algorithm 1) can be illustrated as follows.
1. Convert a slots-encoded CKKS ciphertext into a coefficients-encoded CKKS ciphertext via StC.
2. The ciphertext is split into two ciphertexts namely quotient and remainder using Euclidean division by Δ₀=q₀/(2K) (as in [CCKS23]). The quotient ciphertext

$${ct}_{quo} ∈ {ℛ}_{2 K}^{2}$$

encrypts I∈ [symbol] while the remainder ciphertext ctᵣₑₘ∈ [symbol] ² encrypts m−Δ₀·I. The key idea is to bootstrap the discrete CKKS ciphertext ct_{quo}.

Algorithm 1: Bootstrapping based on [KDE+24]

| | Setting: Δ₀ = q₀/(2K). |
|---|---|
| | $Input : ct = Enc ( z ) ∈ {ℛ}_{q}^{2} with z ∈ {N / 2}^{} .$ |
| | $Output : {ct}_{out} ∈ {ℛ}_{Q}^{2} .$ |
| 1 | ct′ ← StC(ct); |
| 2 | ctᵣₑₘ ← [ct′]_{Δ}_{₀} ∈ [symbol] ²; |
| 3 | ${ct}_{quo} ← ( {ct}^{′} - {ct}_{rem} ) / {Δ}_{0} ∈ {ℛ}_{2 K}^{2} ;$ |
| 4 | (ctᵢ)_{0≤i<log}_{₂}_{(2K)} ← BB-BTS*; |
| 5 | for 0 ≤ i < log₂ (2K) do |
| 6 | \| Clean(ctᵢ); |
| 7 | end for |
| 8 | ${ct}_{out} ← {ct}_{rem} + {\sum }_{i = 0}^{{log}_{2} ( 2 K ) - 1} {2}^{i} \cdot {ct}_{i} ;$ |
| 9 | return ctₒᵤₜ. |

3. We bootstrap ct_{quo} using the batched-bits bootstrapping without StC and combining process (denoted as BB-BTS*) to get the ciphertexts (ctᵢ)0≤i<log₂(2K) encrypting each bit of ct_{quo}.
4. We clean each bit using bit cleaning function(s) in [DMPS24] (e.g. h₁(x)=3x²−2x³). We may iteratively clean so that we obtain high precision.
5. The cleaned bits are combined together and added with the remainder ctᵣₑₘ to obtain the original message.

When it comes to achieving high precision, the main observation is that the step (3) needs not be precise. We may use the lowest precision as possible, and clean at the step (4). This significantly reduces the modulus consumption during bootstrapping, as CtS and EvalMod (or EvalExp) consume most of the modulus in conventional bootstrapping methods. Furthermore, the iterative cleaning process in (4) can also be constructed in an efficient way in terms of modulus consumption: one can start with relatively lower precision and gradually increase the precision of cleaning (by adjusting the modulus consumption per cleaning). Note that the StC step (1) should still be precise: one may use other techniques (e.g. [CCKS23]) to tackle this problem.

### 3.2: Based on [KPK+22]

Let m∈ [symbol] be a plaintext at the bottom modulus q0. Once we ModRaise a ciphertext that encrypts m, a small multiple of the base modulus is added and the output ciphertext encrypts a m+q₀·I instead of m. The main algorithm of [KPK+22] is to regard m+q₀·I as encrypting I with some error, remove (erroneous) m, and subtract the result from the original m+q₀·I. Here they no longer need to keep the precision of m, so they used relatively much smaller rescaling moduli for the CtS step of bootstrapping, saving in modulus consumption by 1-2 multiplicative depths.

While following their philosophy, we analyze the algorithm in a different point of view. Our key observation is that m+q₀·I can be regarded as a discrete CKKS ciphertext encrypting I, as I is an integer polynomial that belongs to [−K, K] for a small integer K. Hence we may clean this ciphertext, outputting a ciphertext that encrypts q0·I as in the main algorithm of [KPK+22].

To efficiently clean m+q₀·I, we adopt the decompose-clean-and-recombine strategy illustrated in [BKSS24]. To reduce the modulus consumption, we start from a very low precision and gradually increase the precision as we proceed sequential cleaning.

Algorithm 2: Bootstrapping based on [KPK+22]

| | Setting: Δ₀ << q₀. |
|---|---|
| | $Input : ct = Enc ( z ) ∈ {ℛ}_{q}^{2} with z ∈ {N / 2}^{} .$ |
| 1 | ct′ ← ModRaise(ct); |
| 2 | ct″ ← StC ○ Clean ○ BitExtract ○ CtS(ct′); |
| 3 | ctₒᵤₜ ← ct′ − ct″; |
| 4 | return ctₒᵤₜ. |

TABLE 1
Experimental Result

| log N | log q | log p | BTS time | BTS prec |
|---|---|---|---|---|
| 16 | 61 × 33 | 61 × 11 | 38 sec | −84.8 |

EvalRound strategy: The strategy of [KPK+22] consists in homomorphically cleaning an encryption of m+q₀·I by evaluating Id−EvalMod in a circuit in which each level has the same precision. On the contrary, we present a novel strategy in which the precision of each level is gradually increased. Such approach allows to benefit from low-precision computation at the early stage of the circuit which leads to a reduced modulus consumption and better efficiency [CCKK24].

The core cleaning property of our algorithm is based on a idea introduced by [DMPS24]. In order to clean noisy binary values in approximate homomorphic encryption, it's sufficient to approximately evaluate the polynomial h₁(x)=3x²−2x³. It asymptotically doubles the precision as the derivatives of such polynomial vanish at 0 and 1. However, such cleaning property is capped by the induced Rescale error. Our new strategy consists in composing such polynomials taking into account the required precision of each step. It carefully chooses the smallest scaling factors for each level while preserving the cleaning property.

One way to extend the bit cleaning composition strategy to integers would be to compose integer cleaning with more and more precise EvalRound. Such approach induces a huge computational overhead.

To avoid that issue, we propose to first convert the integer into smaller words and apply the much cheaper gradual cleaning to them and eventually combine them back to a cleaned integer. A very efficient procedure to extract bits from roots of unity has been proposed by [BKSS24] by jointly evaluating sparse bits extraction polynomials. We remark that a polynomial of degree 7 approximating the complex exponential function can already map the segment [−iπ, iπ] to the unit circle with ≈12 bits of precision.

Some data structures can be very efficiently cleaned while others are notoriously difficult. In particular, noisy roots of unity can be cleaned with very simple polynomials [DMPS24, BKSS24] while integers are usually cleaned through EvalMod with [KPK+22]. This leads us to evaluate EvalRound by first decomposing the integers into small words, cleaning them and combining them back to an integer. The following table compares costs of different cleaning polynomials for t-th roots of unity for various positive integers t

TABLE 2
Caption

| t | log₂(t) | cleaning polynomial | mult. gates | multiplicative depth |
|---|---|---|---|---|
| 2 | 1.00 | $\frac{3}{2} X - \frac{{X}^{3}}{2}$ | 2 | 2 |
| 3 | 1.58 | $\frac{4}{3} X - \frac{{X}^{4}}{3}$ | 2 | 2 |
| 4 | 2.00 | $\frac{5}{4} X - \frac{{X}^{5}}{3}$ | 3 | 3 |

Interestingly, 3rd roots of unity can encode log₂ (3)≃1.58 bits of information and can be cleaned for the same cost as for bits. After cleaning, our method combines these smaller words back to an integer. As a step occurring after cleaning, reconstructing the integer is done in the high precision regime. The arithmetic circuit to convert small words to a single integer becomes heavier and heavier with the size of the word. From a binary decomposition of the integer, a few addition gates are sufficient to reconstruct the integer. From decomposition into 3rd roots of unity, we can avoid multiplication gates by using the conjugate. For t=4, we found it impossible to map them to an integer without consuming a level (ES).

In short, the present invention proposes to interpret EvalRound as Recombine-Clean-Decompose instead of Id−EvalMod.

### 3.3: Efficiency Comparison

We analyze the efficiency of our algorithms, while comparing with the state-of the-art methods including [BCC+22].

### Comparing Algorithm 1 and Algorithm 2

1. Modulus Consumption: We first compare the step before ModRaise. In Algorithm 1, they use Δ₀=q₀/(2K) and m [symbol] (m−Δ₀I, I+(2K)J).

Here they extract I from I+(2K)J. There is no point of increasing the gap between I and J because it only degrades the efficiency. For extracting I from I+(2K)J, one may use scaling factor Δ·(2K) to maintain a precision ≈Δ. On the other hand, in Algorithm 2, they maintain a gap between m and q0, and regard the ciphertext m+q₀·I as a noisy encryption of I.

### REFERENCES

[AAB+23] R. Agrawal, J. H. Ahn, F. Bergamaschi, R. Cammarota, J. H. Cheon, F. D. M. de Souza, H. Gong, M. Kang, D. Kim, J. Kim, H. de Lassus, J. H. Park, M. Steiner, and W. Wang. High-precision ms-ckks on fixed but smaller word-size architectures: theory and application. In WAHC, 2023.
[AJLA+12] G. Asharov, A. Jain, A. López-Alt, E. Tromer, V. Vaikuntanathan, and D. Wichs. Multiparty computation with low communication, computation and interaction via threshold fhe. In EUROCRYPT, 2012.
[BCC+22] Y. Bae, J. H. Cheon, W. Cho, J. Kim, and T. Kim. META-BTS: Bootstrapping precision beyond the limit. In ACM CCS, 2022.
[BCKS24] Y. Bae, J. H. Cheon, J. Kim, and D. Stehlé. Bootstrapping bits with CKKS. In EUROCRYPT, 2024.
[BGG+18] D. Boneh, R. Gennaro, S. Goldfeder, A. Jain, S. Kim, P. M. R. Rasmussen, and A. Sahai. Threshold cryptosystems from threshold fully homomorphic encryption. In CRYPTO, 2018.
[BGGJ20] C. Boura, N. Gama, M. Georgieva, and D. Jetchev. CHIMERA: combining ring-LWE-based fully homomorphic encryption schemes. J. Math. Cryptol., 2020.
[BKSS24] Y. Bae, J. Kim, D. Stehlé, and E. Suvanto. Bootstrapping small integers with CKKS, 2024. To appear in the proceedings of ASIACRYPT′24 personal communication, available upon request from Bae et al.
[CCKK24] Jung Hee Cheon, Hyeongmin Choe, Minsik Kang, and Jaehyung Kim. Grafting: Complementing RNS in CKKS. Cryptology ePrint Archive, Paper 2024/1014, 2024. https://eprint.iacr.org/2024/1014.
[CCKS23] J. H. Cheon, W. Cho, J. Kim, and D. Stehlé. Homomorphic multiple precision multiplication for CKKS and reduced modulus consumption. In CCS, 2023.
[CGGI16] I. Chillotti, N. Gama, M. Georgieva, and M. Izabachène. Faster fully homomorphic encryption: Bootstrapping in less than 0.1 seconds. In ASIACRYPT, 2016.
[CHK 18] J. H. Cheon, K. Han, A. Kim, M. Kim, and Y. Song. Bootstrapping for approximate homomorphic encryption. In EUROCRYPT, 2018.
[CKKL24] H. Chung, H. Kim, Y.-S. Kim, and Y. Lee. Amortized large look-up table evaluation with multivariate polynomials for homomorphic encryption. IACR eprint 2024/274, 2024.
[CKKS17] J. H. Cheon, A. Kim, M. Kim, and Y. Song. Homomorphic encryption for arithmetic of approximate numbers. In ASIACRYPT, 2017.
[DM15] L. Ducas and D. Micciancio. FHEW: Bootstrapping homomorphic encryption in less than a second. In EUROCRYPT, 2015.
[DMPS24] N. Drucker, G. Moshkowich, T. Pelleg, and H. Shaul. BLEACH: Cleaning errors in discrete computations over CKKS. J. Cryptol., 2024.
[JM22] C. S. Jutla and N. Manohar. Sine series approximation of the mod function for bootstrapping of approximate he. In EUROCRYPT, 2022.
[KDE: 24] A. Kim, M. Deryabin, J. Eom, R. Choi, Y. Lee, W. Ghang, and D. Yoo. General bootstrapping approach for RLWE-based homomorphic encryption. IEEE Trans. Comput., 2024.
[KPK 22] S. Kim, M. Park, J. Kim, T. Kim, and C. Min. EvalRound algorithm in CKKS bootstrapping. In ASIACRYPT, 2022.
[KSS24] J. Kim, J. Seo, and Y. Song. Simpler and faster BFV bootstrapping for arbitrary plaintext modulus from CKKS. Cryptology ePrint Archive, Paper 2024/109, 2024.
[LLK 22] Y. Lee, J.-W. Lee, Y.-S. Kim, Y. Kim, J.-S. No, and H. Kang. Highprecision bootstrapping for approximate homomorphic encryption by error variance minimization. In EUROCRYPT, 2022.
[LM21] B. Li and D. Micciancio. On the security of homomorphic encryption on approximate numbers. In EUROCRYPT, 2021.
[LMSS22] B. Li, D. Micciancio, M. Schultz, and J. Sorrell. Securing approximate homomorphic encryption using differential privacy. In CRYPTO, 2022.
[LW24] Z. Liu and Y. Wang. Relaxed functional bootstrapping: A new perspective on BGV/BFV bootstrapping. IACR eprint 2024/172, 2024.
[MHWW24] S. Ma, T. Huang, A. Wang, and X. Wang. Accelerating BGV bootstrapping for large p using null polynomials over Zpe. In EUROCRYPT, 2024.
[MTPBH21] C. Mouchet, J. Troncoso-Pastoriza, J.-P. Bossuat, and J.-P. Hubaux. Multiparty homomorphic encryption from ring-learning-with-errors. Proceedings on Privacy Enhancing Technologies, 2021.

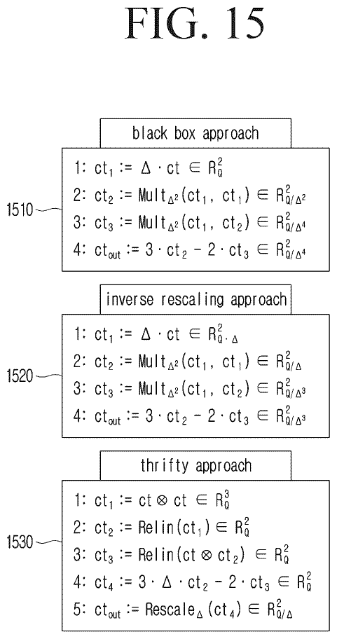

FIG. 15 is a diagram for illustrating a bit cleaning operation according to an embodiment.

The electronic apparatus 100 may perform a bit cleaning operation based on the algorithm disclosed in FIG. 15. As an example, a function for bit cleaning may be 3x²−2x³.

Referring to the embodiment 1510 in FIG. 15, the electronic apparatus 100 may obtain a first value ct1 by multiplying the ciphertext (ct) by the scaling factor Δ for a bit cleaning operation. Here, the modulus may be Q.

The electronic apparatus 100 may obtain a second value ct2 by applying a Mult function based on the first value ct1. Here, the modulus may be Q/Δ².

The Mult function may mean a homomorphic multiplication. Also, the Mult function may mean a homomorphic operation of multiplying two ciphertexts. The Mult function may be a function that receives inputs of two ciphertexts, and returns a result of multiplying them as a new ciphertext. Also, the Mult function may be a function that performs a relinearization operation for reducing a dimension of a multiplication result of a multiplication operation of two ciphertexts, and a rescale operation for normalizing a scaling factor that increased after a multiplication. The Mult function may perform a rescale operation as much as a defined scaling factor. In the embodiment 1510, the Mult function may perform a rescale operation as much as Δ².

The electronic apparatus 100 may obtain a third value ct3 by multiplying a Mult function based on the first value ct1 and the second value ct2. Here, the modulus may be Q/Δ⁴.

The electronic apparatus 100 may obtain an output value ct_out by calculating 3ct2-2ct3 based on the second value ct2 and the third value ct3. Here, the modulus may be Q/Δ⁴.

Referring to the embodiment 1520 in FIG. 15, the electronic apparatus 100 may obtain a first value ct1 by multiplying the ciphertext ct by the scaling factor Δ for a bit cleaning operation. Here, the modulus may be ΔQ.

The electronic apparatus 100 may obtain a second value ct2 by applying a Mult function based on the first value ct1. Here, the modulus may be Q/Δ.

The electronic apparatus 100 may obtain a third value ct3 by applying a Mult function based on the first value ct1 and the second value ct2. Here, the modulus may be Q/Δ³.

The electronic apparatus 100 may obtain an output value ct_out by calculating 3ct2-2ct3 based on the second value ct2 and the third value ct3. Here, the modulus may be Q/Δ³.

Referring to the embodiment 1530 in FIG. 15, the electronic apparatus 100 may obtain a first value ct1 by performing a multiplication operation of the ciphertext (ct) and the ciphertext (ct). Here, the modulus may be Q.

The electronic apparatus 100 may obtain a second value ct2 by performing relinearization for the first value ct1. Here, the modulus may be Q.

The electronic apparatus 100 may obtain a third value ct3 by performing relinearization for a multiplication operation of the ciphertext (ct) and the second value ct2. Here, the modulus may be Q.

The electronic apparatus 100 may obtain a fourth value ct4 by calculating 3Δct2-2ct3 based on the second value ct2 and the second value ct2. Here, the modulus may be Q.

The electronic apparatus 100 may obtain an output value ct_out by performing rescale as much as Δ for the fourth value ct4. Here, the modulus may be Q/Δ.

The modulus of the output value ct_out obtained in the embodiment 1510 in FIG. 15 may be Q/Δ⁴. The modulus of the output value ct_out obtained in the embodiment 1520 in FIG. 15 may be Q/Δ³. The modulus of the output value ct_out obtained in the embodiment 1530 in FIG. 15 may be Q/Δ. The embodiment 1520 may secure a modulus more than the embodiment 1510 as much as A. The embodiment 1530 may secure a modulus more than the embodiment 1510 as much as Δ².

Methods according to the aforementioned various embodiments of the disclosure may be implemented in forms of applications that can be installed on conventional electronic apparatuses.

Also, the methods according to the aforementioned various embodiments of the disclosure may be implemented just with software upgrade, or hardware upgrade for a conventional electronic apparatus.

In addition, the aforementioned various embodiments of the disclosure may be implemented through an embedded server provided on an electronic apparatus, or an external server of at least one of an electronic apparatus or a display device.

Also, according to an embodiment of the disclosure, the aforementioned various embodiments may be implemented as software including instructions stored in machine-readable storage media, which can be read by machines (e.g.: computers). The machines refer to apparatuses that call instructions stored in a storage medium, and can operate according to the called instructions, and the apparatuses may include an electronic apparatus according to the aforementioned embodiments. In case an instruction is executed by a processor, the processor may perform a function corresponding to the instruction by itself, or by using other components under its control. An instruction may include a code that is generated or executed by a compiler or an interpreter. A storage medium that is readable by machines may be provided in the form of a non-transitory storage medium. Here, the term ‘non-transitory’ only means that the storage medium does not include signals and is tangible, and the term does not distinguish whether data is stored in the storage medium semi-permanently or temporarily.

In addition, according to an embodiment of the disclosure, the methods according to the aforementioned various embodiments may be provided while being included in a computer program product. A computer program product refers to a product, and it can be traded between a seller and a buyer. A computer program product can be distributed in the form of a storage medium that is readable by machines (e.g.: compact disc read only memory (CD-ROM)), or may be distributed on-line through an application store. In the case of on-line distribution, at least a portion of a computer program product may be stored in a storage medium such as the server of the manufacturer, the server of the application store, and the memory of the relay server at least temporarily, or may be generated temporarily.

Further, each of the components (e.g.: a module or a program) according to the aforementioned various embodiments may consist of a singular object or a plurality of objects. In addition, among the aforementioned corresponding sub components, some sub components may be omitted, or other sub components may be further included in the various embodiments. Alternatively or additionally, some components (e.g.: a module or a program) may be integrated as an object, and perform functions that were performed by each of the components before integration identically or in a similar manner. Also, operations performed by a module, a program, or other components according to the various embodiments may be executed sequentially, in parallel, repetitively, or heuristically. Or, at least some of the operations may be executed in a different order or omitted, or other operations may be added.

Also, while preferred embodiments of the disclosure have been shown and described, the disclosure is not limited to the aforementioned specific embodiments, and it is apparent that various modifications may be made by those having ordinary skill in the technical field to which the disclosure belongs, without departing from the scope of the disclosure as claimed by the appended claims. Further, it is intended that such modifications are not to be interpreted independently from the technical idea of the disclosure.

1. An electronic apparatus comprising:
at least one processor including processing circuitry; and
memory,
wherein the at least one processor is configured to:
based on an instruction for an operation for a first ciphertext, perform an operation action for the first ciphertext,
obtain a second ciphertext including a noise based on the operation action,
based on identifying a predetermined event on the basis of a modulus of the second ciphertext, obtain an output ciphertext having a bigger modulus than the modulus of the second ciphertext by performing bootstrapping on the basis of a first scaling factor, a second scaling factor, and a third scaling factor different from one another, and
perform an additional operation action based on the output ciphertext.

2. The electronic apparatus of claim 1,
wherein the modulus is a reference value used for limiting a size of a number in an operation action.

3. The electronic apparatus of claim 1,
wherein the at least one processor is configured to:
based on the modulus of the second ciphertext being smaller than or equal to a threshold value, identify that the predetermined event occurred.

4. The electronic apparatus of claim 1,
wherein the at least one processor is configured to:
based on the second scaling factor different from the first scaling factor, obtain a coefficient-encoded third ciphertext by performing Slots-to-Coefficients (StC) conversion for the second ciphertext, and
obtain the output ciphertext by performing modulus expansion for the third ciphertext.

5. The electronic apparatus of claim 4,
wherein the at least one processor is configured to:
obtain a fourth ciphertext by performing ModRaise of expanding the modulus for the third ciphertext, and
obtain the output ciphertext based on the fourth ciphertext.

6. The electronic apparatus of claim 5,
wherein the at least one processor is configured to:
based on the third scaling factor smaller than the second scaling factor, obtain a slot-encoded fifth ciphertext by performing first coefficients-to-slots (CtS) conversion for the fourth ciphertext,
obtain a sixth ciphertext by filtering a second portion other than the first portion indicating an integer in the fifth ciphertext, and
obtain the output ciphertext based on the sixth ciphertext.

7. The electronic apparatus of claim 6,
wherein the at least one processor is configured to:
obtain a slot-encoded seventh ciphertext by performing second coefficients-to-slots (CtS) conversion for the fourth ciphertext based on the second scaling factor, and
obtain the output ciphertext based on the sixth ciphertext and the seventh ciphertext.

8. The electronic apparatus of claim 7,
wherein the at least one processor is configured to:
obtain an eight ciphertext indicating the output ciphertext by subtracting the sixth ciphertext from the seventh ciphertext.

9. The electronic apparatus of claim 8,
wherein the at least one processor is configured to:
obtain the eight ciphertext by using the first scaling factor instead of the second scaling factor.

10. The electronic apparatus of claim 9,
wherein the at least one processor is configured to:
obtain a remaining modulus based on a difference value between a modulus of the eighth ciphertext and a modulus of the second ciphertext, and
perform the additional operation action based on the remaining modulus.

11. A controlling method of an electronic apparatus, the method comprising:
based on an instruction for an operation for a first ciphertext, performing an operation action for the first ciphertext;
obtaining a second ciphertext including a noise based on the operation action;
based on identifying a predetermined event on the basis of a modulus of the second ciphertext, obtaining an output ciphertext having a bigger modulus than the modulus of the second ciphertext by performing bootstrapping on the basis of a first scaling factor, a second scaling factor, and a third scaling factor different from one another; and
performing an additional operation action based on the output ciphertext.

12. The controlling method of claim 11,
wherein the modulus is a reference value used for limiting a size of a number in an operation action.

13. The controlling method of claim 11,
wherein the obtaining the output ciphertext comprises:
based on the modulus of the second ciphertext being smaller than or equal to a threshold value, identifying that the predetermined event occurred.

14. The controlling method of claim 11,
wherein the obtaining the output ciphertext comprises:
based on the second scaling factor different from the first scaling factor, obtaining a coefficient-encoded third ciphertext by performing Slots-to-Coefficients (StC) conversion for the second ciphertext; and
obtaining the output ciphertext by performing modulus expansion for the third ciphertext.

15. The controlling method of claim 14,
wherein the obtaining the output ciphertext comprises:
obtaining a fourth ciphertext by performing ModRaise of expanding the modulus for the third ciphertext; and
obtaining the output ciphertext based on the fourth ciphertext.

16. The controlling method of claim 15,
wherein the obtaining the output ciphertext comprises:
based on the third scaling factor smaller than the second scaling factor, obtaining a slot-encoded fifth ciphertext by performing first coefficients-to-slots (CtS) conversion for the fourth ciphertext;
obtaining a sixth ciphertext by filtering a second portion other than the first portion indicating an integer in the fifth ciphertext; and
obtaining the output ciphertext based on the sixth ciphertext.

17. The controlling method of claim 16,
wherein the obtaining the output ciphertext comprises:
obtaining a slot-encoded seventh ciphertext by performing second coefficients-to-slots (CtS) conversion for the fourth ciphertext based on the second scaling factor; and
obtaining the output ciphertext based on the sixth ciphertext and the seventh ciphertext.

18. The controlling method of claim 17,
wherein the obtaining the output ciphertext comprises:
obtaining an eight ciphertext indicating the output ciphertext by subtracting the sixth ciphertext from the seventh ciphertext.

19. The controlling method of claim 18,
wherein the obtaining the output ciphertext comprises:
obtaining the eight ciphertext by using the first scaling factor instead of the second scaling factor.

20. The controlling method of claim 19,
wherein the performing the additional operation action comprises:
obtaining a remaining modulus based on a difference value between a modulus of the eighth ciphertext and a modulus of the second ciphertext; and
performing the additional operation action based on the remaining modulus.
